(19) United States
(12) Patent Application Publication
(10) Pub. No.: US 2007/0204637 A1
(43) Pub. Date: Sep. 6, 2007

(54) Brine-type cooling apparatus and operation control method of same

(75) Inventors: Takahisa Fujii, Kariya-city (JP); Yuji Ito, Okazaki-city (JP); Yasuhiko Niimi, Handa-city (JP); Takashi Yamamoto, Okazaki-city (JP); Eiichi Kamei, Nisshin-city (JP); Takahiro Yoshida, Niwa-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/713,111

(22) Filed: Mar. 1, 2007

(30) Foreign Application Priority Data
Mar. 2, 2006 (JP) 2006-055794
Aug. 24, 2006 (JP) 2006-228032
Dec. 15, 2006 (JP) 2006-339224

(51) Int. Cl. F25D 17/02; B60H 1/32; F25D 23/12

(52) U.S. Cl. 62/185; 62/239; 62/434; 62/259.2

(57) ABSTRACT

A brine-type cooling apparatus applied to a vehicle equipped with a vehicle air conditioning case 11, a blower 13, and an air conditioner control ECU 23 as air conditioner controlling means, said brine type cooling apparatus comprising a heat absorbing member 8 for absorbing heat from an electronic equipment 7, a heat radiating member 2 for discharging the absorbed heat, a brine pipeline 6 and a circulation pump 9, and a cooling apparatus control ECU 30 as cooling apparatus controlling means. Even when the air conditioner control ECU 23 stops the blower 13 as air conditioner control, an air flow rate is controlled to set an airflow rate of the blower 13 to a predetermined flow rate based on the brine temperature detected by an inlet water temperature sensor 32.

### BACKGROUND OF THE INVENTION

1. Technical Field of the Invention

The present invention relates to a brine-type cooling apparatus, used in vehicle, for cooling an object to be cooled such as vehicle-mounted electronic equipment.

2. Description of the Related Art

In recent years, the amount of electronic equipment mounted on a vehicle, such as audio equipment, various ECUs (electronic control units), a thin film transistor liquid crystal display (TFT), and a head-up display, etc., has increased such that, due to increase of overall heat generation of this electronic equipment as well as increase of heat density resulting from size reduction of various equipment, an adequate cooling capability has become more and more necessary.

At present, efficient natural heat radiation or forced air cooling using a fan is employed for cooling these electronic equipments. In addition, it is also envisaged to utilize a water cooling apparatus as shown in Japanese Patent Publication NO. 2002-353668.

An air conditioning apparatus is disclosed in Japanese Patent Publication No. 2001-1753 but this apparatus is not intended to cool vehicle-mounted electronic equipment. This air conditioning apparatus employs brine as heat exchanging medium to cool a cold heat storage agent. In this apparatus, the air conditioner is in operation while the vehicle is running (during operation of the engine) by driving a pump of the cold heat storage cycle such that, after brine is cooled in an evaporator, it can be circulated in a cold heat storage agent cooler, and during an idling stop, while waiting for change of the traffic sign, the compressor of the air conditioner is stopped and a fan in the cold heat storage module can be driven by a battery so as to cool the vehicle by the cold heat of the cold heat storage agent.

However, in the case of utilizing natural heat radiation, it is necessary to provide a large size heat sink in the electronic equipment to be cooled and, in the case of utilizing forced air cooling, a dedicated cooling fan and a heat sink must be provided integrally in one unit with the electronic equipment. Further, in the case of utilizing a water cooling system as a cooling apparatus as disclosed in prior art references, the dedicated cooling unit is integrated with the electronic equipment to be cooled, resulting in increase in overall dimension of the system.

Thus, in any case, there is a problem that the overall size of the apparatus, including the target object to be cooled, is increased, and vehicle-mounting performance is thereby degraded.

Therefore, the present inventor examined the feasibility of employing brine type cooling apparatus as a cooling apparatus for cooling a target object to be cooled such as a vehicle mounted electronic equipment, which is constructed such that brine is cooled in an evaporator as disclosed in Japanese Patent Publication No. 2001-1753. With a brine type cooling apparatus having such construction, an existing vehicle-mounted evaporator can also be used as a heat radiator for the target object to be cooled, so that a dedicated heat radiator, a heat sink or a cooling apparatus, need not be provided. Thus, a size increase of the system can be avoided, and a cooling apparatus having improved vehicle-mounting performance can be obtained. A brine type cooling apparatus having the construction such that a blower of a vehicle-mounted air conditioner can be used for air cooling of the heat radiator of the brine type cooling apparatus was also examined. With a brine type cooling apparatus having such construction, a need for providing a dedicated blower may be eliminated by using a blower of a vehicle-mounted air conditioner, so that size increase of the system can be avoided and a cooling apparatus having improved vehicle-mounting performance can be obtained.

However, with a brine type cooling apparatus having the construction such that an evaporator or a blower of an air conditioner is used for cooling the brine, there is a problem that, when the compressor or the blower of the air conditioner is stopped for a prolonged period, there are no means for ensuring sufficient capability for cooling the brine, and the target object to be cooled may not be cooled adequately.

### SUMMARY OF THE INVENTION

In view of the above problem, it is a first object of the present invention to provide a cooling apparatus that is capable of cooling a target object to be cooled without increasing overall dimension of the system including the target object to be cooled, and it is a second object of the invention to provide a cooling apparatus capable of ensuring the capability of cooling brine even when a compressor or the like of an air conditioner is stopped.

In order to attain above object, in accordance with a first aspect of the present invention, a cooling apparatus comprises a heat absorbing member (8) that causes brine to absorb the heat of a vehicle-mounted target object to be cooled (7) to thereby cool the target object to be cooled, a heat radiating member (2) that causes the heat of the brine to the air in the air conditioning case to be radiated, a pump (9) for circulating the brine between the heat absorbing member and the heat radiating member, and cooling apparatus control means (30) that controls such that the air in the air conditioning case flows to air cool the heat radiating member, in the case where control of the blower for the air conditioner executed by the air conditioner control means is stops controlling the blower.

In accordance with the present invention, as the blower of the vehicle-mounted air conditioner can be utilized by sharing, a dedicated blower or the like need not be provided, so that a size increase of the system can be avoided, and a cooling apparatus having an improved vehicle-mounting performance can be obtained.

When the construction in which the heat radiating member (2) of the brine type cooling apparatus radiates the heat of the brine, to the air in the air conditioning case, is adopted, there is also a problem that, when the blower is stopped, air cooling of the heat radiating member by the blower is stopped and cooling capability of the brine type cooling apparatus is degraded.

Therefore, in the present invention, when the target object to be cooled needs to be cooled by brine in case where control of the blower for the air conditioner executed by the air conditioner control means is stop control of the blower, the cooling apparatus control means (30) controls such that the air in the air conditioning case is caused to flow for air cooling of the heat radiating member. Thus, even in such a case, adequate cooling capability of the brine type cooling apparatus can be ensured.

As the control for causing the air in the air conditioning case to flow, a control for air cooling the heat radiating member by using, for example the cooling apparatus control means (30) to operate the blower so as to cause the air in the air conditioning case to flow can be adopted.

In this case, the cooling apparatus control means (30) can be controlled, for example, such that, when a physical quantity detected by detection means exceeds a predetermined first threshold value, the blower is operated with a predetermined air flow rate greater than 0.

The vehicle-mounted target object to be cooled is, for example, a vehicle mounted electronic equipment (7) or an interior component of a compartment (50) or the like. The vehicle mounted electronic equipment (7) is, for example, a CPU in an ECU, a TFT display board, a back-light of HUD, a power device of an audio equipment, etc. with especially large heat generation. The interior component of a compartment (50) is, for example, a leather seat for the occupant to be seated, or an instrument panel or a ceiling likely to be heated to high temperature by solar radiation.

In accordance with a second aspect of the present invention, temperature of the brine (Tin, Tout) in the brine line is detected, and a blower (13) for blowing air to an evaporator (1) is operated in accordance with the detected brine temperature (Tin, Tout).

As the control for letting air flow in the air conditioning case, a control can be adopted, for example, such that the cooling apparatus control means (30) operates a blower means for the heat radiating member (26) to thereby let flow the air in the air conditioning case and to air-cool the radiating member.

In this case, the cooling apparatus control means (30) can be controlled, for example, such that, when a physical quantity detected by detection means exceeds a predetermined first threshold value, the blower means for the heat radiating member (26) is operated with a predetermined air flow rate greater than 0.

Also, as the control for letting air flow in the air conditioning case, a control can be adopted, for example, such that the cooling apparatus control means (30) locates an external-internal air switching door at a position suitable for introducing air from outside the room to thereby let flow the air in the air conditioning case and to air-cool the heat radiating member.

In this case, the cooling apparatus control means (30) can be controlled, for example, such that, when a physical quantity detected by detection means exceeds a predetermined first threshold value, the external-internal air switching door is located at a position so as to introduce the external air from outside the vehicle room in a predetermined amount greater than 0.

Also, when the cooling apparatus control means (30) are controlled to let flow the air in the air conditioning case, an exhaust heat vent (19d) capable of being opened and closed can be provided on the air conditioner unit (10) and the cooling apparatus control means (30) can be controlled to locate the door for opening and closing the exhaust heat vent at a position to open the exhaust heat vent to discharge the air after heat radiation from the exhaust heat vent. Here, it is preferred that the exhaust heat vent be located at a position where air does not impinge directly to the occupant. It is also possible that, by opening at least one of the defroster vent and the foot vent, the air from the vent is not noticed by the occupant as far as possible.

In accordance with a third aspect of the present invention, to a refrigeration cycle, a brine circuit (6) for circulating brine as heat exchanging medium is provided via a heat radiating member (2) that is constructed in thermally conductive contact with the low pressure path side of the refrigeration cycle, and vehicle-mounted electronic equipment (7) to be cooled is interposed in the brine circuit (6) via a heat absorbing member (8) that is constructed in thermally conductive contact with the vehicle-mounted electronic equipment (7), and the operation of a compressor (14) in the refrigeration cycle is controlled based on the temperature (Ta) of the brine circulating in the brine circuit (6).

In accordance with the invention, a part of the vehicle-mounted refrigeration cycle can be jointly used as a heat radiator, so that a dedicated heat radiator or a heat sink or a cooling apparatus need not be provided, and size increase of the system can be thereby avoided and a cooling apparatus having improved vehicle-mounting performance can be obtained.

Also, heat from the brine is not radiated in the interior of the room that is an air conditioned space, but can be radiated via the refrigeration cycle to the outside of a car. Thus, need of the air cooling inside the car is eliminated, and the occupant is not exposed to disagreeable warm air.

For example, said heat radiating member (2) may be constructed in thermally conductive contact with an evaporator (1) on the side of low pressure path of said refrigeration cycle. With such construction, the brine circulating in the brine circuit can be conveniently cooled.

As an operation control method for controlling the operation of the brine type cooling apparatus of the third aspect, a method can be employed comprising the steps of reading temperature Ta of the brine circulating in said brine circuit, determining whether or not said temperature Ta is equal to or lower than a predetermined temperature T2 set in advance lest the vehicle-mounted electronic equipment is excessively cooled to cause dew condensation, and if Ta≦T2, turning the compressor to OFF and returning to START, or if Ta≧T2, determining whether or not said temperature Ta is equal to or higher than a predetermined temperature T1, set in advance lest the vehicle-mounted electronic equipment is excessively heated, and if T1≦Ta, turning the compressor 5 to ON and returning to START, and successively continuing these control procedures. With such control method, dew condensation due to excessive cooling of the brine can be prevented.

In accordance with a fourth aspect of the present invention, to a refrigeration cycle, a brine circuit (6) for circulating brine as heat exchanging medium is provided via a heat radiating member (2) that is constructed in thermally conductive contact with an evaporator (1) on the low pressure path side of the refrigeration cycle, and a vehicle-mounted electronic equipment (7) to be cooled is interposed in the brine circuit (6) via a heat absorbing member (8) that is constructed in thermally conductive contact with the vehicle-mounted electronic equipment (7), and the operation of a compressor (14) in the refrigeration cycle and a pump (9) in the brine circuit (6) is controlled based on monitoring of the temperature (Ta) of the brine circulating in the brine circuit (6) as well as monitoring of the state of the evaporator (1).

In accordance with the invention, a part of the vehicle-mounted refrigeration cycle can be jointly used as a heat radiator, so that a dedicated heat radiator or a heat sink or a cooling apparatus need not be provided, and a size increase of the system can be thereby avoided and a cooling apparatus having improved vehicle-mounting performance can be obtained. Further, with such a construction of the operation control, freezing of the evaporator as well as dew condensation of the vehicle-mounted electronic equipment can be prevented.

As an operation control method for controlling the operation of the brine type cooling apparatus of the fourth aspect, a method can be employed comprising the steps of reading temperature Ta of the brine circulating in said brine circuit on the one hand, reading temperature Tb of the air after passing the evaporator, determining whether or not said air temperature Tb is equal to or lower than a predetermined temperature T4 set in advance lest the evaporator is excessively cooled to be frozen, or determining whether or not said air temperature Tb is equal to or higher than a predetermined temperature T3 set in advance lest the evaporator is excessively heated, or determining whether or not said temperature Ta is equal to or higher than a predetermined temperature T1 set in advance lest the vehicle-mounted electronic equipment is excessively heated, or determining whether or not said air temperature Tb is equal to or higher than a predetermined temperature T3 set in advance lest the evaporator is excessively heated, or determining whether or not the temperature Ta of the brine is equal to or lower than a predetermined temperature T2 or determining whether or not the temperature Ta is equal to or higher than T1, or determining whether or not the compressor is ON, and successively continuing these control procedures. With such a control method, by monitoring the brine temperature Ta and the air temperature Tb after passing the evaporator at any time, freezing of the evaporator and dew condensation of the vehicle-mounted electronic equipment can be prevented.

In accordance with a fifth aspect of the present invention, the cooling apparatus comprises a heat absorbing member (8) for cooling the object to be cooled by causing the heat of the vehicle-mounted object to be cooled (7) to be absorbed by brine, a heat radiating member (2) thermally connected to the side of a low pressure path of a refrigeration cycle for discharging the heat of the brine to a refrigerant in the refrigeration cycle, a pump (9) for circulating the brine between the heat radiating member and the heat absorbing member, and cooling apparatus control means (30) that controls such that, when the control content of a compressor for air conditioning executed by air conditioner control means is to control the amount of refrigerant discharge of the compressor to be 0 and it is required to cool the object to be cooled by brine, the refrigerant in the refrigeration cycle is circulated so as to discharge heat from the heat radiating member to the refrigerant.

In accordance with the invention, a part of the refrigeration cycle for the vehicle-mounted air conditioner can be jointly used, so that a dedicated blower or the like need not be provided, and a size increase of the system can be thereby avoided and a cooling apparatus having improved vehicle-mounting performance can be obtained.

Also, in the case where the construction in which the heat-radiating member (2) of the brine type cooling apparatus is thermally connected to the low pressure path side of the refrigeration cycle and heat of the brine can be discharged to the refrigerant in the refrigeration cycle is adopted, there is a problem that, when the compressor is stopped and the refrigerant is not circulated in the refrigeration cycle, the heat exchange between the heat radiating member and the refrigerant is also stopped and the cooling capability of the brine type cooling apparatus is lowered.

Therefore, in accordance with the invention, when the control content of a compressor for air conditioning executed by air conditioner control means is to control the amount of refrigerant discharge of the compressor to be 0 and it is required to cool the object to be cooled by brine, the cooling apparatus control means (30) controls such that the compressor is caused to discharge the refrigerant so as to circulate the refrigerant in the refrigeration cycle to radiate the heat from the heat radiating member to the refrigerant. Thus, even in such a case, a cooling capability of the brine type cooling apparatus can be ensured.

For example, the cooling apparatus control means (30) can be controlled such that, when a physical quantity detected by detection means exceeds a predetermined first threshold value, the compressor can be caused to discharge the refrigerant in a predetermined refrigerant discharging amount set to be greater than 0.

It is preferred that, in order to discharge heat from the brine to the refrigerant in the evaporator, the heat radiating member (2) be constructed in thermal connection to the evaporator (1). The construction of the heat radiating member (2) in thermal connection to the evaporator (1) includes, besides direct contact of the heat radiating member (2) with the evaporator (1), cases where another member is interposed between the heat radiating member (2) and the evaporator (1) as long as heat transfer is possible between the heat radiating member (2) and the evaporator (1).

The reference numeral in parenthesis used in Claims and for various means herein is an example of correspondence to specific means described in the embodiments to be described later.

The present invention may be more fully understood from the description of preferred embodiments of the invention, as set forth below, together with the accompanying drawings.

### BRIEF DESCRIPTION OF THE DRAWINGS

In the drawings:

FIG. 1 is a schematic view showing the basic construction of a first embodiment of the present invention;

FIG. 2 is a schematic block diagram showing an air conditioning control ECU in the first embodiment;

FIG. 3 is a flow chart showing the blower control executed by the cooling apparatus control ECU in the first embodiment;

FIG. 4 is a flow chart showing the blower control executed by the cooling apparatus control ECU in another example of the first embodiment;

FIG. 5 is a schematic view showing the overall construction of a brine type cooling apparatus and a vehicle-mounted air conditioning unit according to a second embodiment;

FIG. 6 is a view showing the arrangement an evaporator and a heat radiating member in the second embodiment;

FIG. 7 is a view showing the arrangement an evaporator and a heat radiating member in the second embodiment;

FIG. 8 is a view showing the arrangement an evaporator and a heat radiating member in the second embodiment;

FIG. 9 is a schematic view showing the overall construction of a brine type cooling apparatus and a vehicle-mounted air conditioning unit according to a third embodiment;

FIG. 10 is a flow chart showing the blower control executed by the cooling apparatus control ECU in the third embodiment;

FIG. 11 is a flow chart showing the blower control executed by the cooling apparatus control ECU 30 in the fourth embodiment;

FIG. 12 is a schematic view showing the overall construction of a brine type cooling apparatus and a vehicle-mounted air conditioning unit according to a fifth embodiment;

FIG. 13 is a schematic view showing a brine type cooling apparatus according to a sixth embodiment;

FIG. 14 is a schematic view showing a brine type cooling apparatus according to a seventh embodiment;

FIG. 15 is a flow chart showing the control executed by the cooling apparatus control ECU of the brine type cooling apparatus as shown in FIG. 14;

FIG. 16 is a schematic view showing a brine type cooling apparatus according to another example of the seventh embodiment;

FIG. 17 is a flow chart showing the control executed by the cooling apparatus control ECU of the brine type cooling apparatus as shown in FIG. 16;

FIG. 18 is a schematic view showing a brine type cooling apparatus according to a eighth embodiment;

FIG. 19 is a flow chart showing the refrigerant discharge control executed by the cooling apparatus control ECU of the eighth embodiment;

FIG. 20 is a schematic view showing a brine type cooling apparatus according to a first example of another embodiment; and

FIG. 21 is a schematic view showing a brine type cooling apparatus according to a second example of another embodiment.

### DESCRIPTION OF THE PREFERRED EMBODIMENTS

### First Embodiment

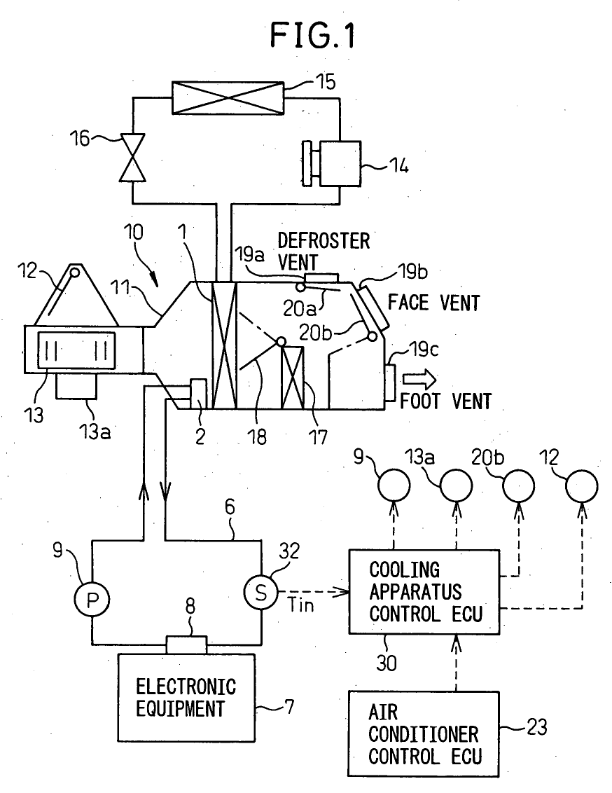

FIG. 1 is a schematic view showing the construction of a brine type cooling apparatus according to the first embodiment of the invention.

A brine type cooling apparatus according to this embodiment is to be mounted to a vehicle that is equipped with a vehicle air conditioner, and comprises a heat absorbing member 8 for absorbing heat from an electronic equipment 7 to be cooled, a heat radiating member 2 for discharging the heat absorbed by the heat absorbing member 8, a brine pipeline 6 and a circulation pump 9 for circulating the brine between the heat absorbing member 8 and the heat radiating member 2, an inlet water temperature sensor 32 for detecting brine temperature Tin on the inlet side of the electronic equipment 7, and a cooling apparatus control ECU 30 as means for controlling the cooling apparatus. The brine 60 is a heat exchanging medium, for example a liquid, mainly consisting of fluoride.

On the other hand, as the vehicle air conditioner, an air conditioning unit 10 comprises an air conditioning case 11, an external-internal air switching door 12, a blower 13, an evaporator 1, a compressor 14, a condenser 15, an expansion valve 16, a heater core 17, an air mix door 18, a defroster vent 19a, a face vent 19b, a foot vent 19c provided on the air conditioning case 11, each door 20a, 20b for opening and closing each vent, and an air conditioner control ECU 23 as means for controlling the air conditioner.

Thus, the heat radiating member 2 is disposed at a position exposed to the wind from the blower 13 in the air conditioning case 11, and heat is exchanged between the heat radiating member 2 and the air stream in the air conditioning case 11, such that heat of the heat radiating member 2 is discharged to the air, that is, the heat radiating member 2 is air cooled by the wind from the blower 13. The heat radiating member 2 has a passage for brine formed therein.

Here, in the case where the heat radiating member 2 is disposed outside the air conditioning case 11, a dedicated blower is required for air cooling of the heat radiating member 2. In this embodiment, however, the existing blower 13 in the air conditioning unit 10 is used for air cooling of the heat radiating member 2, so that need for a dedicated blower is eliminated. Therefore, in accordance with this embodiment, the number of components of the brine type cooling apparatus can be decreased as compared to the case where the heat radiating member 2 is disposed outside the air conditioning case 11.

The cooling apparatus control ECU 30 is composed of a well-known microcomputer including a CPU, ROM, and RAM, etc. and peripheral circuits, and the control program for controlling the air conditioner is stored in ROM, and various operations and processing are performed based on the control program.

An inlet water temperature sensor 32 is connected to the input side of the cooling apparatus control ECU 30, and detection result of the brine temperature Tin is inputted from the inlet water temperature sensor 32 to the cooling apparatus control ECU 30. Also, in order for the cooling apparatus control ECU 30 to monitor the control of a driving motor 13a of the blower 13 by the air conditioner control ECU 23, the air conditioner control ECU 23 is connected to the input side of the ECU 30, so that the control content of the driving motor 13a of the blower 13 by the air conditioner control ECU 23 is inputted to the cooling apparatus control ECU 30.

To the output side of the cooling apparatus control ECU 30, electric driving means for the brine circulating pump 9, the driving motor 13a of the blower 13, and the door 20b for opening and closing the foot vent 19c, are connected, and operation of the circulating pump 9, the blower 13, and the door 20b is controlled by the control signal outputted from the cooling apparatus control ECU 30. Although the operation of the blower 13 is controlled by the control signal outputted from the air conditioner control ECU, the operation control of the blower 13 by the cooling apparatus control ECU 30 takes precedence over the operation control of the blower 13 by the air conditioner control ECU in the present embodiment.

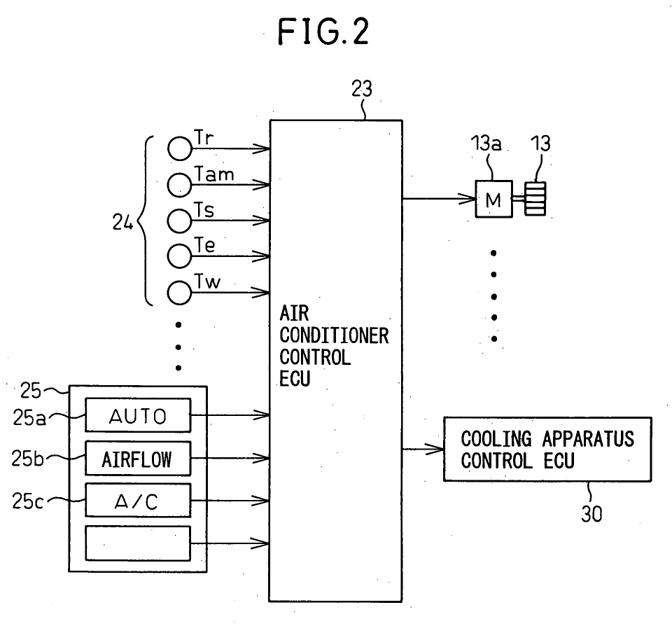

Next, the air conditioner control ECU 23 will be described in outline. FIG. 2 shows a schematic block diagram of the air conditioner control ECU 23. The air conditioner control ECU 23 is composed of a well known microcomputer including CPU, ROM, and RAM, etc., and its peripheral circuits, and the control program for controlling the air conditioner is stored in ROM, and various operations and processing are performed based on the control program.

To the input side of the air conditioner control ECU 23, a sensor group 24 for detecting the exit air temperature Te of the evaporator, external air temperature Tam, internal air temperature Tr, the amount of solar radiation, warm water temperature Tw, etc., and various operating switches 25a˜25c of the air conditioner panel 25 operated by the occupant, and the like, are connected, and detection signal from the sensors of the sensor group 24, and operation signal from the air conditioner panel 25, and the like, are inputted to the air conditioner control ECU 23.

Various operating switches provided on the air conditioner panel 25 include, for example, an automatic air conditioning switch 25a, an airflow rate switch 25b, air conditioner switch 25c, and the like. The automatic air conditioning switch 25a outputs a signal for automatic air conditioner control to be performed by the air conditioner control ECU 23, the airflow rate switch 25b outputs a signal for manually setting on/off of the blower 13 and airflow rate switching of the blower 13, and the air conditioner switch 25c outputs a on/off signal for the compressor 14.

To the output side of the air conditioner control ECU 23, the compressor 14, the driving motor 13a for the blower 13, and electric driving means for various equipments are connected, and operation of this equipment is controlled by the output signal of the air conditioner control ECU 23. For example, voltage applied to the driving motor 13a of the blower 13 is controlled by an unshown drive circuit, and rotational speed of the driving motor 13a is thereby controlled. The drive circuit controls the applied voltage based on the blower control signal from the air conditioner control ECU 23, and airflow rate of the blower 13 is thereby adjusted.

When the automatic air conditioning switch 25a is off, the air conditioner control ECU 23 controls the operation of various equipments such as the compressor 14, the blower 13, etc., based on the operating signal from various operating switches of the operation panel 25 operated by the occupant. When the automatic air conditioning switch 25a is on, the air conditioner control ECU 23 reads-in the set temperature from the temperature setting switch of the air conditioner panel 25, reads-in the state of the vehicle environment from the sensor group 24, and then calculates the target blow-out temperature of the air conditioner wind to be blown out into the room, determines the control state of various equipments such as the compressor 14, the blower 13, etc., based on the calculated result, and controls the operation of various equipments by outputting the control signal to various equipment such as the compressor 14, the blower 13, etc.

Next, the control content executed by the cooling apparatus control ECU 30 will be described.

When the ignition switch is turned on, the cooling apparatus control ECU 30 is started simultaneously with the start of the electronic equipment 7.

Basically, when the blower 13 is in operation, the temperature of the brine is maintained at appropriate temperature to cool the electronic equipment 7 by controlling the amount of discharge from the circulating pump 9 based on the brine temperature detected by the inlet water temperature sensor 32.

On the other hand, when the air conditioner control ECU 23 performs stopping control for the blower 13 to be stopped as the control for the air conditioning, a blower control is performed for setting the airflow rate of the blower 13 at a predetermined rate based on the brine temperature detected by the inlet water temperature sensor 32. This is the control for resolving the problem which arises when the blower 13 is stopped, that is, the problem that heat discharge from the heat radiating member 2 is inadequate, and cooling capability of the brine type cooling apparatus cannot be achieved and the electronic equipment 7 to be cooled cannot be cooled adequately.

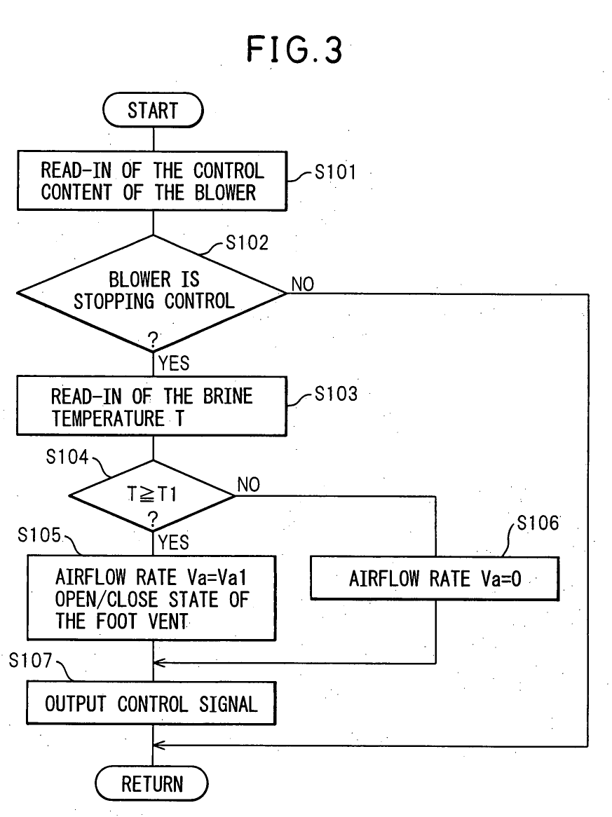

This blower control will be described in detail below. FIG. 3 shows a flow chart of the blower control executed by the cooling apparatus control ECU 30. This control begins with the start of the electronic equipment 7 and ends with the stop of the electronic equipment 7. The flow shown in FIG. 3 is repeated until the end of the control.

First, at step S101, the control content of the blower 13 by the air conditioner control ECU 23 is read-in. The control content of the blower 13 is as follows: when the automatic air conditioning switch 25a is off, the blower 13 is controlled based on the operating signal that is read-in from the airflow rate switch 25b, and when the automatic air conditioning switch 25a is on, the blower 13 is controlled by the control content determined by the air conditioner control ECU 23 before the control signal is outputted to the blower 13.

At step S102, it is determined whether or not the control content of the blower 13 is stopping control. In the case where the air conditioner control ECU 23 is to execute the control for stopping the blower 13 as the control for the air conditioning, it is determined to be YES, and the flow proceeds to step S103. The case where the air conditioner control ECU 23 is to execute the control for stopping the blower 13 as the control for the air conditioning is, for example, the case where the automatic air conditioning switch 25a is off and the operating position of the airflow rate switch 25b is at the airflow rate 0, or where the automatic air conditioning switch 25a is on and the air conditioner control ECU 23 decides the airflow rate of the blower 13 to be 0, or where the blower 13 is to be stopped because of system anomaly. On the other hand, in the case where the air conditioner control ECU 23 is to run the blower 13, it is determined to be NO, and the flow shown in FIG. 3 comes to an END and returns to START.

At step S103, the brine temperature T is read-in from the inlet water temperature sensor 32. Then, at step S104, it is determined whether or not the read-in brine temperature T is equal to or higher than a predetermined threshold temperature T1. Here, the predetermined threshold temperature T1 is a temperature set as a boundary temperature at which the need for the electronic equipment 7 to be cooled by the brine arises. When, for example, upper bound of the temperature of the electronic equipment 7 is about 80° C., the threshold temperature T1 is set at 70° C. If the brine temperature is equal to or higher than 70° C., for example, it is determined to be YES and the flow proceeds to step S105, and if the brine temperature is lower than 70° C., for example, it is determined to be NO and the flow proceeds to step S106.

At step S105, as the electronic equipment must be cooled by the brine, the airflow rate Va of the blower 13 is decided to be a predetermined flow rate Va1 greater than 0, and the OPEN/CLOSE state of the foot vent 19c is decided to be OPEN. On the other hand, at step S106, as the electronic equipment need not be cooled by the brine, the airflow rate Va of the blower 13 is decided to be 0. After step S105 or S106, at step S107, a control signal is outputted for bringing the blower 13 and the door 20 to the decided control state. At steps S105, S107, the position of the external-internal air switching door 12 is decided to be, for example, an internal air introducing position, and a control signal is outputted to the electric driving means of the external-internal air switching door 12. Then, the flow returns to START and step S101 is executed.

In this way, in the present embodiment, in the case where the cooling apparatus control ECU 30 determines, at step S102, that the control content of the blower 13 by the air conditioner control ECU 23 is stopping control, and at step S104, the brine temperature T is equal to or higher than T1, the blower is operated and the air in the air conditioning case 11 is thereby let flow at steps S105, S107.

Thus, in accordance with this embodiment, even when the blower 13 needs not be operated as the control for air conditioning, if it is required to cool the electronic equipment, the blower 13 can be made to continue operation. Even in the case where the blower 13 is stopped by usual air conditioner control, cooling capability of the brine type cooling apparatus can be secured.

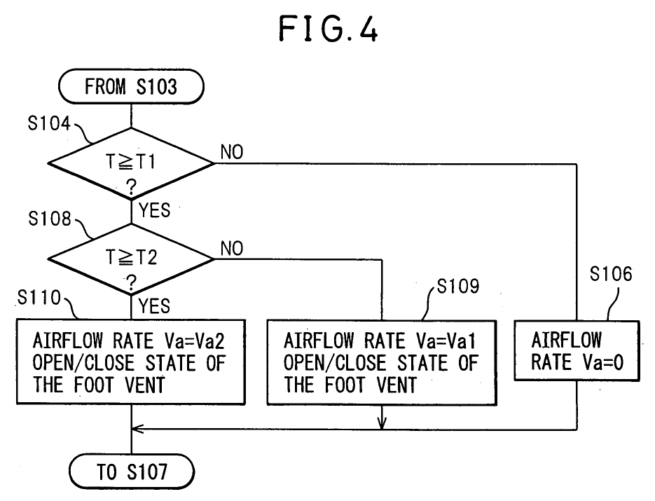

Although, in the present embodiment, in the blower control of FIG. 3 executed by the cooling apparatus control ECU 30, when the control content of the blower 13 to be executed by the air conditioner control ECU 23 is the stopping control, the brine temperature T is compared with the threshold temperature T1 and the airflow rate of the blower 13 is decided to be either a predetermined flow rate greater than 0 or 0 at steps S104, S105, S106, it is also possible to modify the step S105 in FIG. 3, to steps S108-S110 as shown in FIG. 4, so as to subdivide the predetermined flow rate greater than 0 into plural stages in accordance with the brine temperature.

Thus, flow may be modified as follows: as shown in FIG. 4, if it is determined, at step S104, that the brine temperature T is equal to or higher than the first threshold temperature T1, it is further determined, at step S108, whether or not the brine temperature T is equal to or higher than the second threshold temperature T2 higher than the first threshold temperature T1, and if, as a result, it is determined that the brine temperature T is lower than the second threshold temperature T2, it is decided, at step S109, that the airflow rate Va of the blower 13 should be a first predetermined flow rate Va1 greater than 0, and the foot vent 19c be opened. On the other hand, if the brine temperature T is equal to or higher than the second threshold temperature T2, it is decided, at step S110, that the airflow rate Va of the blower 13 should be a second predetermined flow rate Va2 greater than the first predetermined flow rate Va1, and the foot vent 19c be opened. Here, the second threshold temperature T2 is higher than the first threshold temperature T1, and for example, the first threshold temperature T1 may be set to 70° C. and the second threshold temperature T2 may be set to 75° C.

With such construction, in the case where the control content of the blower 13 to be executed by the air conditioner control ECU 23 is stopping control, the blower 13 can be operated with the airflow rate of the blower 13 set in accordance with the amount of heat discharge required for the brine, so that the brine can be adequately air cooled by the blower 13. In the case where the flow shown in FIG. 3, FIG. 4 is repeatedly executed, when the temperature of the brine rises, the airflow rate of the blower 13 can be increased from Val to Va2.

In another example of the present embodiment, in the case where, although the blower 13 need not be operated as the control for air conditioning by the air conditioner control ECU 23, the blower 13 is operated for some purpose, for example, with airflow rate set to a flow rate Va3 that is not noticed by the occupant, when the air conditioner control ECU 23 decides that the blower 13 need not be operated as the control for air conditioning, the blower 13 may be operated with the airflow rate Va set to a flow rate Va4 greater than Va3.

### Second Embodiment

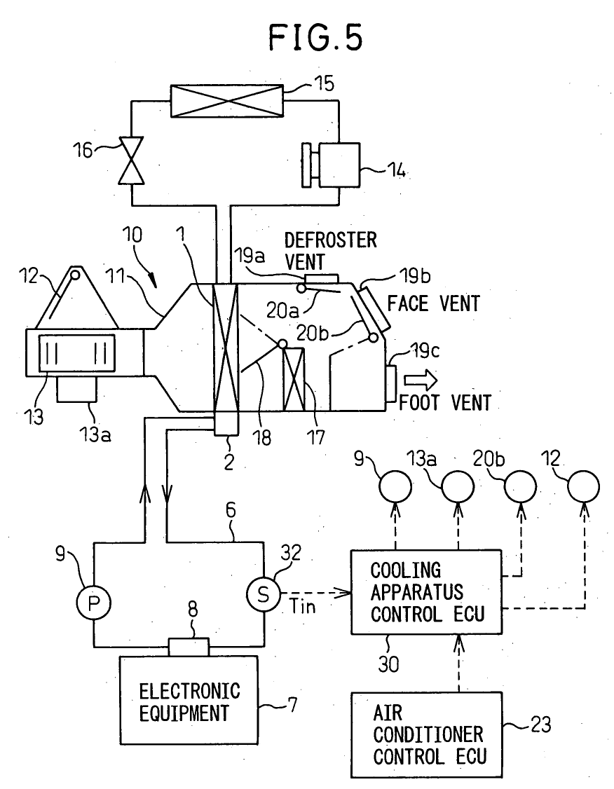

FIG. 5 is a schematic view showing a brine type cooling apparatus according to a second embodiment of the invention. In FIG. 5, like constituents as in FIG. 1 are denoted by same reference numerals.

Although, in the first embodiment, the heat radiating member 2 is disposed in the air conditioning case 11, the heat radiating member 2 is disposed outside the air conditioning case 11 in this second embodiment.

This heat radiating member 2 is in contact with the evaporator 1 so as to permit heat conduction to the evaporator 1.

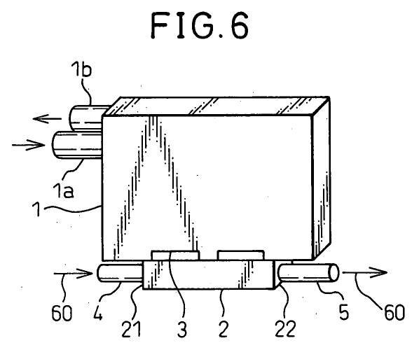

Specifically, for example, as shown in FIG. 6, in the case of tube fin structure in which the evaporator 1 has a tank section in communication with a tube, the heat radiating member 2 is disposed in contact with the tank section located on the lower side of the evaporator 1 in the Figure.

The heat radiating member 2 has a passage for brine 60 formed therein, and is connected to the inlet brine pipeline 4 and the outlet side brine pipeline 5 at the inlet opening 21 and the outlet opening 22, respectively, provided at the ends of the passage. The brine 60 flows through the inlet side brine pipeline 4 into the heat radiating member 2, and after heat exchange with the evaporator 1 via the heat radiating member 2 and brazed section 3, flows out into the outlet side brine pipeline 5. These brine pipeline 4, 5 on the inlet side and the outlet side form a part of a loop-like brine pipeline 6. The heat radiating member 2 is constructed from, for example, Al, or Cu based metal of high thermal conductivity, or resins.

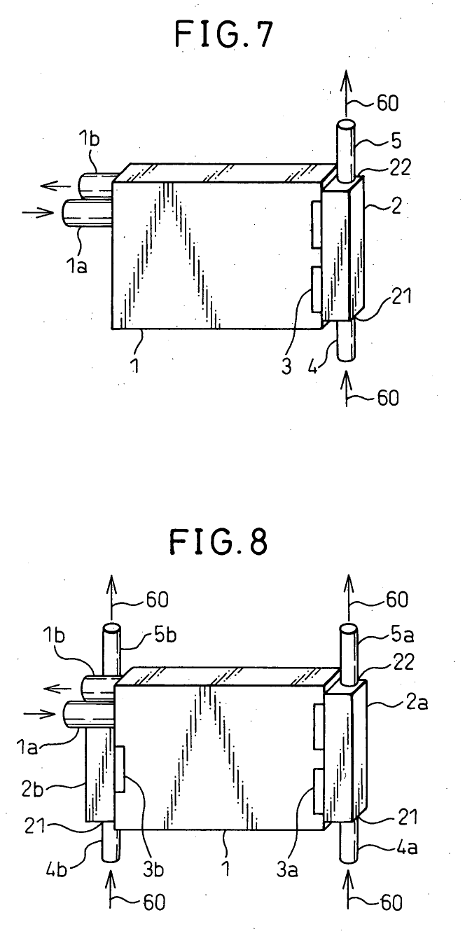

It is also possible to construct such that, as shown in FIG. 7, the heat radiating member 2 is in contact with the side plate section located on the right side of the evaporator 1 in the Figure.

With the construction in which the heat radiating member 2 is in contact with the tank section of the evaporator 1, higher heat radiating capability of the heat radiating member 2 can be achieved as compared to the construction in which the heat radiating member 2 is in contact with the side plate of the evaporator 1. This is because, when the evaporator 1 has the tube fin structure, tank section is in contact with a plurality of tubes whereas the side plate is in contact with the fin, and the tube has higher thermal conductivity than the fin.

It is also possible to construct, as shown in FIG. 8, such that a plurality of heat radiating members 2 are in contact with the evaporator 1. In FIG. 8, two heat radiating members 2a, 2b are thermally in contact with the evaporator 1 via brazed sections 3a, 3b. The heat radiating members 2a, 2b are connected, as in the first embodiment, to the brine pipeline 4a, 4b, respectively, at the inlet section, and to the brine pipeline 5a, 5b, respectively, at the outlet section. These brine pipelines 4a, 4b are branched from one brine pipeline 6 on the upstream side of the heat radiating members 2a, 2b, and the brine flows into the heat radiating members 5a, 5b, respectively. The brine pipelines 5a, 5b let the brine 60 flow on the downstream side of the heat radiating members 2a, 2b, and are combined into one brine pipeline 6.

In the present embodiment, the heat radiating member 2 is disposed outside the air conditioning case 11, but is in contact with the evaporator 1 so as to permit heat conduction to the evaporator 1. Thus, heat of the brine is transferred from the to heat radiating member 2 to the evaporator 1, and the heat stored in the evaporator 1 is carried away by the wind. Further, when the refrigeration cycle is in operation, the heat of the brine is carried away by the refrigerant, too.

### Third Embodiment

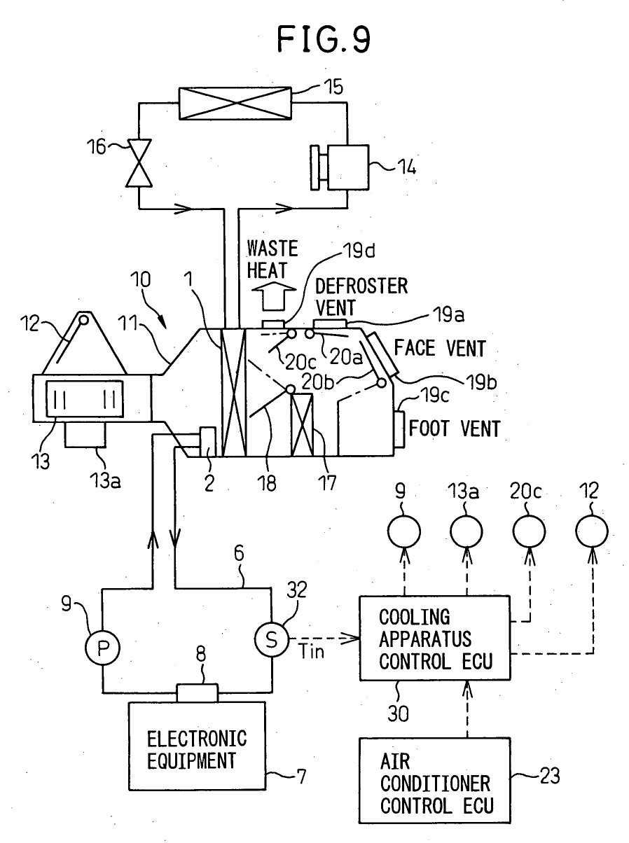

FIG. 9 is a schematic view showing a brine type cooling apparatus according to the third embodiment, and in FIG. 9, like constituents as in FIG. 1 are denoted by the same reference numerals.

In this third embodiment, besides the defroster vent 19a, the face vent 19b, and the foot vent 19c, there is provided a waste heat vent 19d together with a waste heat door 20c for opening/closing the waste heat vent 19d.

The waste heat vent 19d is disposed at a position where the occupant is not directly exposed to the wind, so that the occupant is not aware of the wind from the vent. The position where the occupant is not directly exposed to the wind is, for example, a position where the wind is blown out of the room, or a position in the room where the wind is directed to the windshield or to the feet of the occupant. The waste heat door 20c is connected to the output side of the cooling apparatus control ECU 30, so that opening/closing of the waste heat vent 19d by means of the waste heat door 20c is controlled by the control signal outputted from the cooling apparatus control ECU 30.

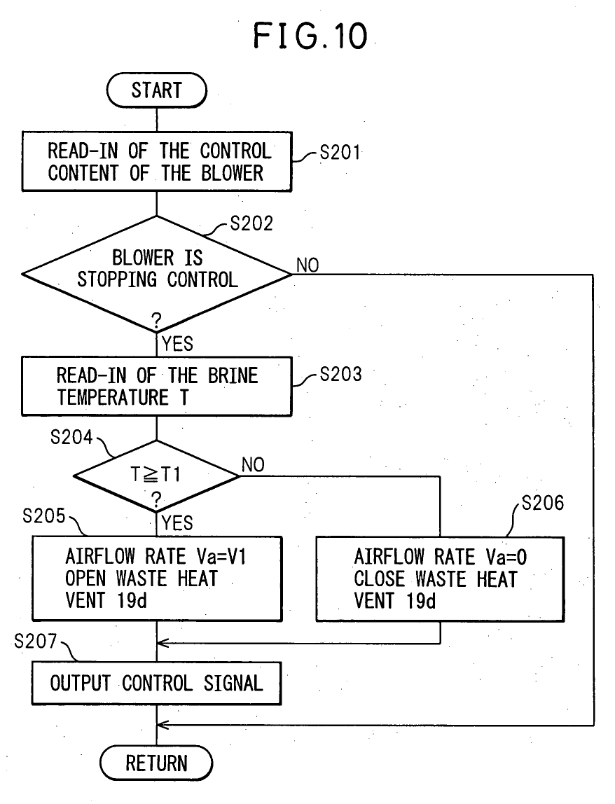

FIG. 10 is a flow chart showing the blower control executed by the cooling apparatus control ECU 30 in the third embodiment. Among the steps in FIG. 10, the steps S201, S202, S203, S204, S207 are respectively the same as the steps S101, S102, S103, S104, S107 shown in FIG. 3 described in the first embodiment, and the steps S205 and S206 are different from the steps S105 and S106 in FIG. 3. Thus, at step S205, it is decided that the airflow rate Va should be the predetermined flow rate V1, and the waste heat vent 19d should be opened, and at step S206, it is decided that the airflow rate Va should be 0, and the waste heat vent 19d should be closed.

Thus, in the present embodiment, in the case where the cooling apparatus control ECU 30 determines, at step S202, that the control content of the blower 13 by the air conditioner control ECU 23 is the stopping control, and at step S204, the brine temperature T is determined to be equal to or higher than the threshold temperature T1, the blower is operated to run and the waste heat vent 19d is opened at steps S205, S207.

Therefore, in accordance with the present embodiment, even when the blower 13 is stopped as the control for air conditioning, if it is required to cool the electronic equipment, the blower 13 can be kept running and, in addition, as the waste heat vent 19d is opened at the time of operation of the blower 13, even though the occupant turns off the automatic air conditioner switch 25a or the air flow rate switch 25b, the brine cooling is possible without giving a disagreeable sense of wind leakage from the foot vent 19c to the occupant.

In the case where, as has been described with reference to the first embodiment, the step S105 in FIG. 3 is modified to the steps S108-S110 so as to subdivide the predetermined amount greater than 0 into plural stages in accordance with the brine temperature, the decision of the foot mode at steps S109, S110 can be modified to the decision that the waste heat vent 19d be opened, and further, a degree of opening of the waste heat vent 19d can be set in accordance with the set airflow rate.

For example, the flow chart may be modified as follows: at step S108, it is determined whether or not the brine temperature T is equal to or higher than the second threshold temperature T2 higher than the first threshold temperature T1 and if, as a result, it is determined that the brine temperature is lower than the second threshold temperature T2, it is decided at step S109 that the airflow rate Va of the blower 13 should be the first predetermined airflow rate Va1 greater than 0, and the degree of opening α of the waste heat vent 19d should be the first degree of opening α1. If it is determined that the brine temperature is equal to or higher than the second threshold temperature T2, it is decided at step S110 that the airflow rate Va of the blower 13 should be the second predetermined airflow rate Va2 greater than the first predetermined airflow rate Va1, and the degree of opening α of the waste heat vent 19d should be the second degree of opening α2 larger than the first degree of opening α1.

### Fourth Embodiment

In this fourth embodiment, in the brine type cooling apparatus having the construction shown in FIG. 1 described with reference to the first embodiment, the blower control executed by the cooling apparatus control ECU 30 is modified.

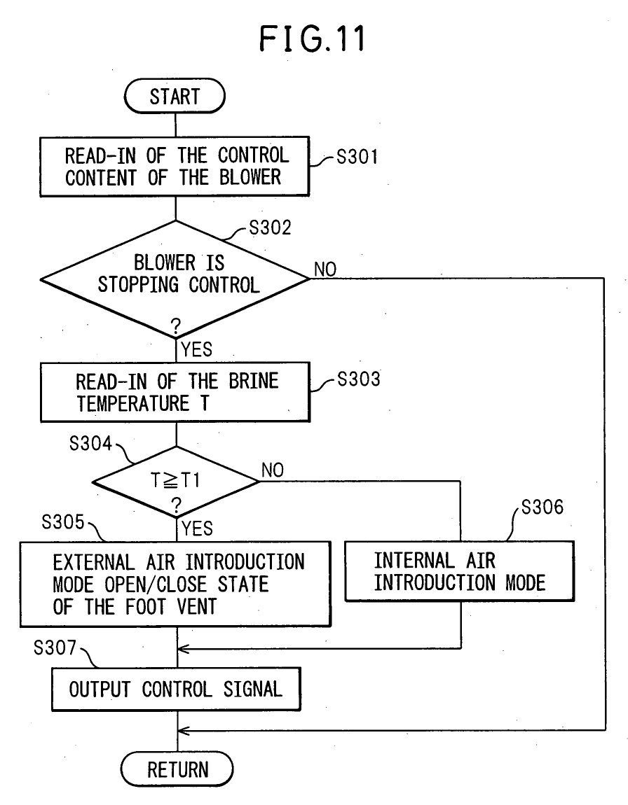

FIG. 11 is a flow chart showing the blower control executed by the cooling apparatus control ECU 30 of the Fourth embodiment. Among various steps in FIG. 11, the steps S301, S302, S303, S304, S307 are the same as the steps S101, S102, S103, S104, S107 in FIG. 3 described with reference to the first embodiment, and the steps S305, S306 are different from the steps S105, S106 in FIG. 4.

Thus, at step S305, the internal/external air introduction mode is decided to be the external air introduction mode, and the discharging mode is decided to be the foot mode, that is, it is decided that the OPEN/CLOSE state of the foot vent 19c should be OPEN. At step S307, a control signal is outputted to the electric driving means for the internal/external air switching door 12 and the door 20 such that the internal/external air switching door 12 and the door 20 is brought to the decided control state.

In this way, in the present embodiment, in the case where the cooling apparatus control ECU 30 determines, at step S302, that the control content of the blower 13 by the air conditioner control ECU 23 is the stopping control, and determines, at step S304, that the brine temperature T is equal to or higher than the threshold temperature T1, at steps S305, S307, the internal/external air switching door 12 is placed at the external air introducing position such that, if the external air inlet port is closed, it is changed to the opened position, and if the external air inlet port is opened position, it is maintained at opened position, and the foot vent is brought to opened state, to thereby let flow the air in the air conditioning case 11.

In this way, in accordance with the present embodiment, even when the blower 13 is stopped as the control for air conditioning, if it is required to cool the electronic equipment, the heat radiating member 2 can be air-cooled and cooling capability of the brine type cooling apparatus can be maintained.

In this embodiment, unlike the first embodiment, the internal/external air switching door 12 is operated in place of the blower 13, so that operating ratio of the blower 13 can be lowered and the durability of the blower can be improved.

The present embodiment is particularly effective when the vehicle is in running state. Therefore, it is preferred to add, for example, the following construction to this embodiment, that is, the construction in which a vehicle speed sensor is connected to the input side of the cooling apparatus control ECU 30. A step in which, from the detection result inputted from the vehicle speed sensor, the cooling apparatus control ECU 30 determines whether or not the vehicle is in running state, is added to the blower control executed by the cooling apparatus control ECU 30. Then, if in running state, at step S305, it is decided that the internal/external air introduction mode should be external air introduction mode.

In the present embodiment, if it is determined, at step S304, that the brine temperature T is equal to or higher than the first threshold temperature T1, the external air introduction mode is decided at step S305. The step S305 may be modified as described in FIG. 4 with reference to the first embodiment, to a step in which it is determined whether or not the brine temperature T is equal to or higher than the second threshold temperature. T2 higher than the first threshold temperature T1, and a step in which, if as a result, the brine temperature T is lower than the second threshold temperature T2, the external air introduction rate Vb is decided to be the first predetermined rate Vb1 greater than 0, or a step in which, if the brine temperature T is equal to or higher than the second threshold temperature T2, the external air introduction rate Vb is decided to be the second predetermined rate Vb2 greater than the first predetermined rate. Thus, the external air introduction rate Vb may be subdivided into plural stages such as the first and second predetermined rate Vb1, Vb2 in accordance with the brine temperature.

With such construction, when the control content of the blower 13 executed by the air conditioner control ECU 23 is the stopping control, the internal/external air switching door 12 can be operated by setting the external air introduction rate Vb in accordance with the amount of heat discharge required for the brine, and the brine can be adequately air-cooled by the blower 13. For example, in the case where the flow in FIG. 11 is repeatedly executed, when the brine temperature rises, it is possible to increase the external air introduction rate Vb from Vb1 to Vb2.

The blower control described in the present embodiment is also applicable to the brine type cooling apparatus having the construction as described in the first, second and third embodiments.

### Fifth Embodiment

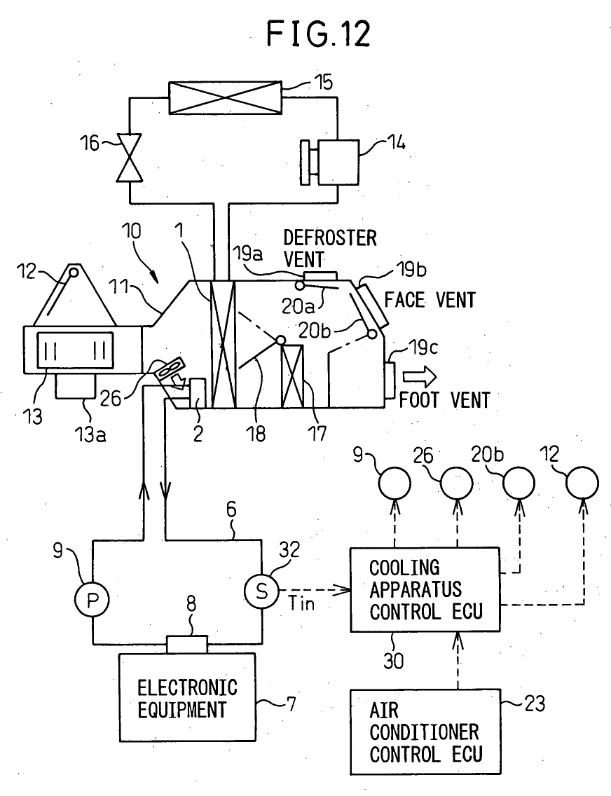

FIG. 12 is a schematic view showing a brine type cooling apparatus according to a fifth embodiment, and in FIG. 12, constituents the same as in FIG. 1 are denoted by the same reference numerals.

The brine type cooling apparatus according to the present embodiment comprises, as shown in FIG. 12, a dedicated fan 26 as blower means for the heat radiating member besides the blower 13, and in the blower control executed by the cooling apparatus control ECU 30 described in the first embodiment, the control is modified to operate this dedicated fan 26 in place of the blower 13.

The dedicated fan 26 is used for air-cooling of the heat radiating member, and is disposed in the air conditioning case 11 at a position capable of directing the wind to the heat radiating member 2. As shown in FIG. 12, in the case where the heat radiating member 2 is disposed on the upstream side in the flow of the wind from the evaporator 1, the dedicated fan 26 is disposed, for example, between the heat radiating member 2 and the evaporator 1. As the dedicated fan, a commonly used fan may be employed.

The dedicated fan 26 is controlled by the cooling apparatus control ECU 30, for example, such that it stops when the blower 13 is in operation, and is operated to run when control of the blower 13 for air conditioning is the stopping control.

The blower control for operating the dedicated fan 26 executed by the cooling apparatus control ECU 30 of the present embodiment will be described below. This blower control modifies the steps S105, S106, S109, S110 in FIGS. 3 and 4 described with reference to the first embodiment such that the airflow rate Va of the blower 13 is replaced by the airflow rate Vc of the dedicated fan 26. Since other steps are the same as in the first embodiment, explanation of the other steps is omitted herein.

In the present embodiment, in the case where the cooling apparatus control ECU 30 determines, at step S102 in FIG. 3, that the control content of the blower 13 by the air conditioner control ECU 23 is stopping control, and at step S104, the brine temperature T is equal to or higher than T1, the control for operating the dedicated fan 26 with the airflow rate Vc set to the predetermined flow rate Vc1 is executed, and the air in the air conditioning case 11 is thereby let flow.

In this way, in the present embodiment, the dedicated fan 26 is operated in place of operating the blower 13, so that, as in the first embodiment, even when the blower 13 is not operated as the control for air conditioning, if it is required to cool the electronic equipment 7, the heat radiating member 2 can be air-cooled and the cooling capability of the brine type cooling apparatus can be ensured.

Also, in the present embodiment, as the dedicated fan 26 is operated in place of operating the blower 13, the operating ratio of the blower 13 can be lowered and durability of the blower can be improved.

Although, in the present embodiment as described above, the dedicated fan is controlled to stop when the blower 13 is in operation by the cooling apparatus control ECU 30, it is also possible to operate the dedicated fan 26 when the blower 13 is in operation. For example, the control such that, when the blower 13 is in operation, the dedicated fan 26 is operated with the first predetermined airflow rate Vc1 in order to supplement the air cooling of the heat radiating member 2 by the blower 13, and when the control of the blower 13 for air conditioning is stopping control, the dedicated fan 26 is operated with the second predetermined airflow rate Vc2 greater than the first predetermined airflow rate Vc1, can be executed by the cooling apparatus control ECU 30.

### Sixth Embodiment

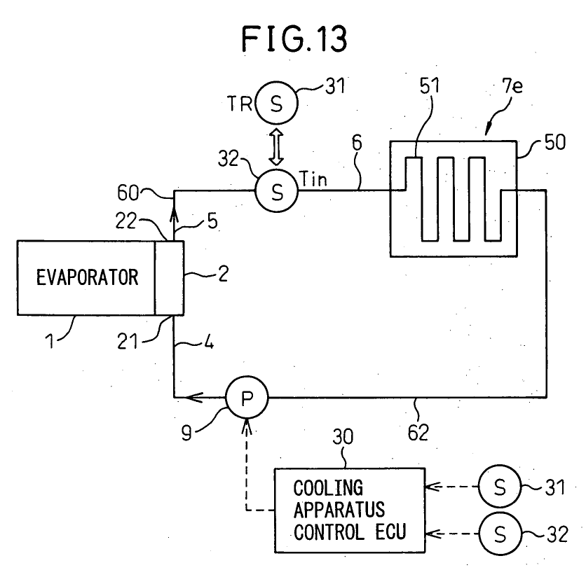

Next, a sixth embodiment of the invention will be described below. In the present sixth embodiment, in place of the electronic equipment 7 in the first embodiment (FIG. 1) described above, an interior equipment is the target object to be cooled 7e. In the following, like constituents as in the first embodiment are denoted by same reference numerals, and an explanation thereof is omitted. FIG. 13 is a schematic view showing a brine type cooling apparatus according to this sixth embodiment. The object to be cooled 7e is an interior equipment which is a seat cooling apparatus with a wavy tube 51 disposed directly under the cover seat for circulating the brine. The wavy tube 51 consists of a meandering silicone tube, and is joined to the seat cover 50 in thermal connection thereto. The inlet side of the wavy tube 51 is connected to the brine pipeline on the downstream side of the inlet water temperature sensor 32, and the outlet side of the wavy tube 51 is connected via the brine pipeline 6 to the circulating pump 9.

In the present sixth embodiment, the object to be cooled by the brine type cooling apparatus is not an electronic equipment, but a seat cooling apparatus. Thus, the brine type cooling apparatus needs to be used with the air conditioner unit 10 operated for air conditioning, that is, with the evaporator 1 cooled by the operation of the compressor 14.

When the inlet side brine temperature Tin detected by the inlet water temperature sensor 32 is higher than the target cooling temperature Tc that is lower than the internal air temperature TR by a predetermined amount (for example, 10° C.), the circulating pump 9 can be turned ON to circulate the brine 60 cooled by the evaporator 1 to the object to be cooled 7e. The cover seat 50 can be thereby cooled down to a temperature lower than the internal air temperature (room temperature) TR.

When the temperature of the evaporator 1 is extremely low (for example 5° C.), the temperature of the heat radiating member 2 thermally connected thereto is also 5° C., and the temperature of the brine is also near 5° C. In this case, if the internal air temperature TR is 30° C., for example, dew condensation is likely to occur in the environment around the brine pipeline 6.

Therefore, when the detected inlet side brine temperature Tin is lower than the target cooling temperature Tc (for example, 30−10=20° C.), the operating voltage of the circulating pump 9 can be lowered to thereby reduce the flow rate, and lowering of the brine temperature in the brine pipeline 6 can be thereby suppressed.

In this way, by controlling the operation of the circulating pump 9 in accordance with the inlet side brine temperature Tin and the target cooling temperature Tc, the brine temperature can be maintained at approximately constant temperature in order to avoid dew condensation.

The target cooling temperature Tc may be varied in accordance with the detected internal air temperature TR. For example, in the case where TR=50° C., Tc can be set to a temperature 20° C. lower than the internal air temperature (that is, 30° C.).

Besides the above-mentioned cover seat 50, the interior equipment as the object to be cooled may be a ceiling of the room or an instrument panel, and the wavy tube for circulating the brine may be embedded in the ceiling or the instrument panel.

### Seventh Embodiment

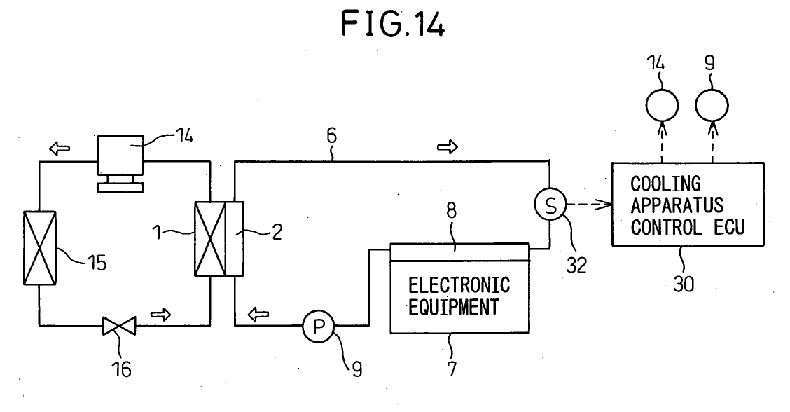

FIG. 14 is a schematic view showing the construction of a brine type cooling apparatus according to a seventh embodiment.

This brine type cooling apparatus is composed of an existing refrigeration cycle and a brine circuit 6 for circulating brine as a heat exchanging medium.

An evaporator 1, a compressor 14, a condenser 15, and an expansion valve 16 are disposed in the refrigeration cycle. The evaporator 1, the compressor 14, the condenser 15, and the expansion valve 16 are well known, and explanation thereof is omitted herein.

On the other hand, a circulation pump 9 for circulating the brine, a temperature sensor 32, and an electronic equipment 7 are interposed in the brine circuit 6. In addition, a heat radiating member 2 constructed in thermally conductive contact with the evaporator 1 disposed on the low pressure side of the refrigeration cycle, and a heat absorbing member 8 constructed in thermally conductive contact with the vehicle-mounted electronic equipment 7 are provided in the brine circuit 6.

The temperature sensor 32 detects the temperature of the brine circulating in the brine circuit 6, and sends a detection signal to the cooling apparatus control ECU 30 and, based on this detection signal on the temperature, the compressor 14 in the refrigeration cycle is ON/OFF controlled in accordance with the predetermined control procedure (to be described later).

Materials of high thermal conductivity (metal or synthetic resin) can be utilized for the heat absorbing member 8 constructed in thermally conductive contact with the vehicle-mounted electronic equipment 7 as for the heat radiating member 2, and any suitable means may be used as fixing means in accordance with such material and structure.

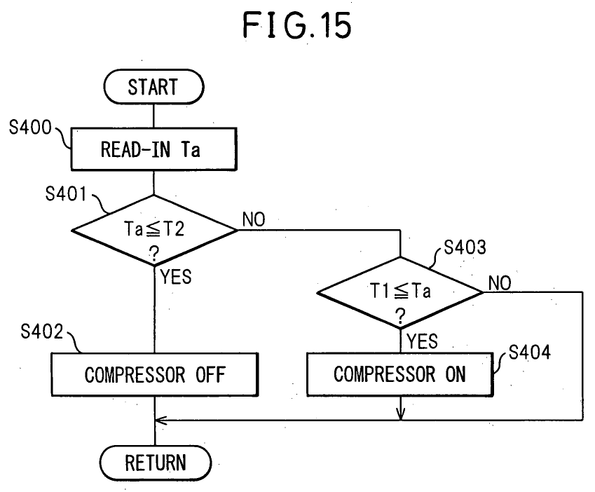

The brine type cooling apparatus according to the present embodiment is constructed as described above. Next, control procedure set in the cooling apparatus control ECU 30 is shown by a flow chart in FIG. 15, and the operation of the cooling apparatus will be described based on the flow chart.

In the brine type cooling apparatus, in air conditioning operation, refrigerant is circulated through the evaporator 1, the compressor 14, the condenser 15, and the expansion valve 16 in the refrigeration cycle, while, in the brine circuit 6, the brine is circulated by the circulation pump 9 via the temperature sensor 32, the vehicle-mounted electronic equipment 7 in the brine circuit, thereby flowing through the heat radiating member 2 constructed in thermally conductive contact with the evaporator 1 in the refrigeration cycle and through the heat absorbing member 8 constructed in thermally conductive contact with the electronic equipment.

Thus, the brine is cooled by passing the heat radiating member 2 constructed in thermally conductive contact with the evaporator 1, and can cool the electronic equipment 7 by passing the heat absorbing member 8 constructed in thermally conductive contact with the electronic equipment.

At this time, at step S400, the cooling apparatus control ECU 30 reads-in the brine temperature Ta circulating in the brine circuit 6 from the detection signal sent by the temperature sensor 32.

Then, at step S401, it is determined whether or not the temperature Ta is equal to or lower than the predetermined temperature T2 (for example, 20° C.). Here, T2 is the temperature that has been set in advance lest the electronic equipment 7 is excessively cooled to cause dew condensation.

If Ta≦T2, the flow proceeds to step S402, and turns the compressor 14 OFF, and returns to START.

If Ta>T2, the flow proceeds to step S403. At step S403, it is determined whether or not the brine temperature is equal to or higher than predetermined temperature T1 (for example 70° C.). Here, T1 is a temperature that has been set so as not to overheat the electronic equipment 7.

If T1≦Ta, the flow proceeds to step S404, and turns the compressor 14 ON, and returns to START.

Operation can be continued by successively repeating the above-described control procedure.

In this way, the electronic equipment 7 in the brine circuit 6 can be conveniently cooled without being overheated. The heat of the brine heated by cooling the electronic equipment 7 can be discharged by passing the heat radiating member 2 constructed in thermally conductive contact with the evaporator 1 in the refrigeration cycle.

Thus, heat is not discharged into the interior of the room that is air conditioned space, but to outside of the vehicle via the refrigeration cycle, so that the need for the wind cooling in the interior is eliminated and the occupant is not exposed to a disagreeable warm wind.

The present embodiment can be modified as follows.

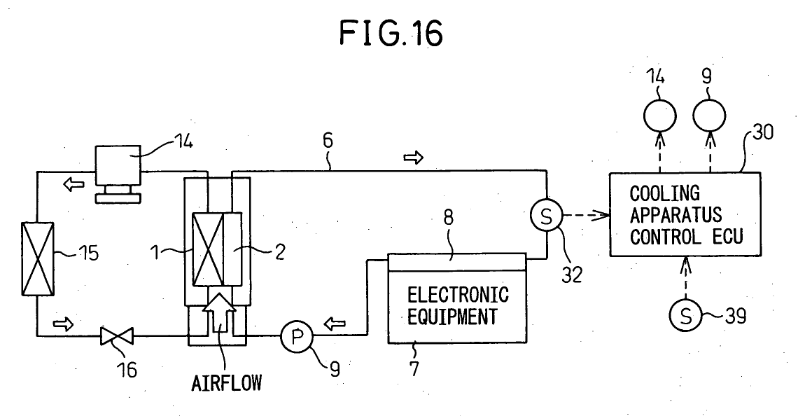

Thus, in the brine type cooling apparatus shown in FIG. 16, the evaporator 1 in the refrigeration cycle is formed as a unit. That is, the evaporator 1 is constructed as a unit separate from other elements such as the compressor 14, the condenser 15, and the expansion valve 16 constituting the refrigeration cycle. The heat radiating member 2 that discharges the heat of the brine circulating in the brine circuit 6 is constructed in thermally conductive contact with this evaporator 1, and wind is directed to the evaporator 1 and the heat radiating member 2 by an unshown blower.

Further, in this brine type cooling apparatus, not only the temperature sensor 32 for detecting the temperature of circulating brine, but also an internal air sensor 39 for detecting the air temperature Tb after passing the evaporator 1 is provided for monitoring the evaporator 1, and based on the detection signal with respect to the air temperature Tb after passing the evaporator 1 and the detection signal with respect to the brine temperature Ta, ON/OFF control of the compressor 14 in the refrigeration cycle and operation control of the circulation pump 9 are executed in accordance with the predetermined control procedure (to be described later).

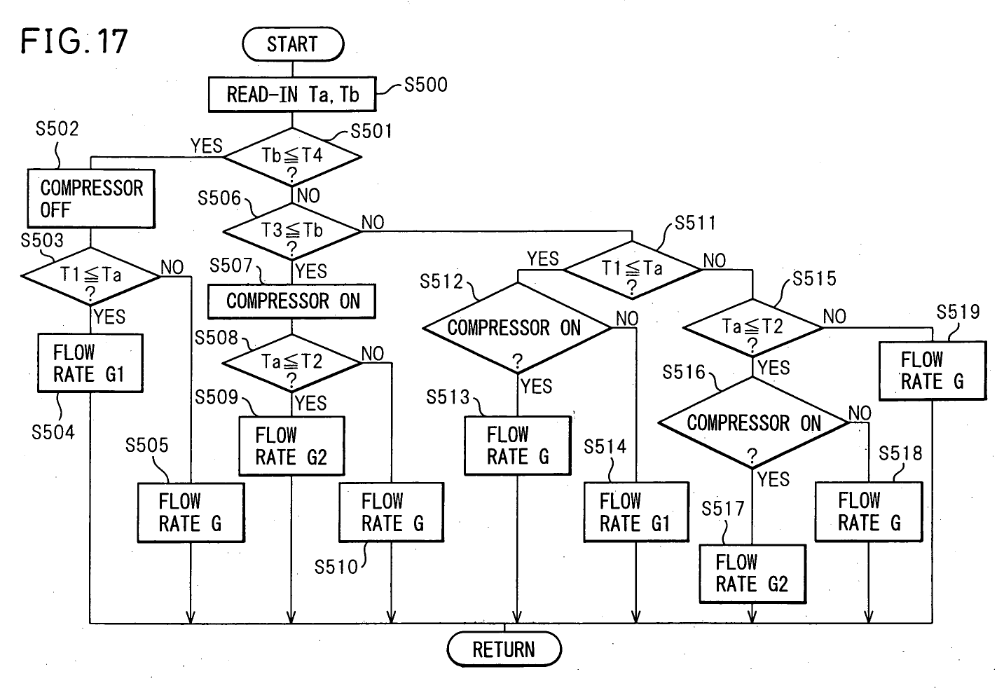

Thus, a procedure that has been set in the cooling apparatus control ECU 30 is shown in FIG. 17. Operation of the above-described brine type cooling apparatus will be explained below based on the flow chart. The following control procedure attempts to resolve the problem that, when the compressor 14 is OFF, and if the compressor 14 is turned ON in accordance with the brine temperature Ta, the evaporator 1 may be frozen due to overcooling, and the problem that, when the compressor 14 is ON, and if the compressor 14 cannot be turned OFF in accordance with the brine temperature Ta, the brine may be overcooled to cause dew condensation. For this purpose, in this control procedure, control is executed with priority set between the “air need” (avoiding freezing of the evaporator 1) and the “electronic need” (brine temperature). Operation will be described below with reference to the control procedure.

In the cooling apparatus control ECU 30, at step S500, the brine temperature Ta and the air temperature Tb after passing the evaporator 1 are read-in, respectively, from the detection signal by the temperature sensor 32 and from the detection signal by the internal air sensor 39.

Next, at step S501, it is determined whether or not Tb is equal to or lower than predetermined temperature T4 (for example, 5° C.). Here, T4 is a temperature that has been set in advance lest the evaporator is excessively cooled to be frozen. If Tb≦T4, the flow proceeds to step S502 (to be described later), turns the compressor 14 OFF and proceeds to step S503 (to be described later).

If Tb>T4, the flow proceeds to step S506 (to be described later).

At step S503, it is determined whether or not Ta is equal to or higher than predetermined temperature T1 (for example, 70° C.). T1 is a temperature that has been set in advance lest the vehicle-mounted electronic equipment 7 is excessively heated.

If T1≦Ta, the flow proceeds to step S504, controls the output of the circulation pump 9 so as to obtain flow rate G1, and returns to START. If T1≧Ta, the flow proceeds to step S505, controls the output of the circulation pump 9 so as to obtain flow rate G, and returns to START. The relation of the flow rate G1 and the flow rate G is G<G1.

Next, at step S506, it is determined whether or not Tb is equal to or higher than a predetermined temperature T3 (for example 10° C.). Here, T3 is a temperature that has been set in advance lest the evaporator 1 is overheated. If T3≦Tb, the flow proceeds to step S507 (to be described later), turns the compressor ON, and proceeds to step S508 (to be described later). If T3>Tb, the flow proceeds to step S511 (to be described later).

At step S508, it is determined whether or not Ta is equal to or lower than a predetermined temperature T2 (for example 20° C.). Here, T2 is a temperature that has been set in advance lest the vehicle-mounted equipment is excessively cooled to cause dew condensation.

If Ta≦T2, the flow proceeds to step S509, controls the output of the circulation pump 9 so as to obtain flow rate of G2, and returns to START. If Ta>T2, the flow proceeds to step S510, controls the output of the circulation pump 9 so as to obtain flow rate of G, and returns to START. Relation of G2 and G is G2<G.

At step S511, it is determined whether or not T1≦Ta. If T1≦Ta, the flow proceeds to step S512 (to be described later), and if T1>Ta, the flow proceeds to step S515 (to be described later).

At step S512, it is determined whether or not the compressor 14 is ON. If the compressor 14 is ON, the flow proceeds to step S513, controls the output of the circulation pump 9 so as to obtain flow rate of G, and returns to START. If the compressor is OFF, the flow proceeds to step S514, controls the output of the circulation pump 9 so as to obtain flow rate of G1, and returns to START.

At step S515, it is determined whether or not Ta≦T2. If Ta≦T2, the flow proceeds to step S516 (to be described later), and if Ta>T2, the flow proceeds to step S519, controls the output of the circulation pump 9 so as to obtain flow rate of G, and returns to START.

At step S516, it is determined whether or not the compressor 14 is ON. If the compressor 14 is ON, the flow proceeds to step S517, controls the output of the circulation pump 9 so as to obtain flow rate of G2, and returns to START. If the compressor is OFF, the flow proceeds to step S518, controls the output of the circulation pump 9 so as to obtain flow rate of G, and returns to START.

By successively continuing the control procedure described above, the brine temperature Ta, and the air temperature Tb after passing the evaporator 1 are monitored at all times, and the initial objects, that is, prevention of freezing of the evaporator 1 and prevention of the dew condensation of the electronic equipment 7, can be attained.

As has been described above, in the brine type cooling apparatus shown in FIG. 16, in the case where the compressor 14 is required to be turned OFF for prevention of freezing of the evaporator 1 during the operation of air conditioner, and the brine is required to be cooled for heat discharge from the vehicle-mounted electronic equipment, it is possible to effectively utilizing the difference of heat capacity of the brine in the brine circuit as a whole by increasing the output of the circulation pump 9 and increasing the flow rate of the brine. Further, thermal conductance of the heat absorbing member 8 and the heat radiating member 2 can be improved by increasing the flow speed.

In this way, while the heat discharging capability is enhanced, temperature rise of the evaporator 1, and hence prevention of freezing, becomes possible.

Further, in the case where the compressor 14 is required to be turned ON for prevention of the overheat of the evaporator 1 during the operation of air conditioner, and the brine is required to be heated for prevention of dew condensation of the vehicle-mounted electronic equipment, it is possible to produce difference of heat capacity in the brine in the brine circuit as a whole by decreasing the output of the circulation pump 9 and decreasing the flow rate of the brine. Further, thermal conductance of the heat absorbing member 8 and the heat radiating member 2 can be lowered by decreasing the flow speed.

In this way, while the heat discharging capability is suppressed, temperature rise of the brine, and hence prevention of dew condensation, becomes possible.

In this brine type cooling apparatus, as has been described, the compressor 14 is turned ON/OFF based on the procedure set in the cooling apparatus control ECU 30. In the case where the compressor 14 is a variable capacity compressor, ON/OFF control can be replaced by the increase/decrease of the capacity. Of course, as the output control method of the circulation pump 9, in place of the stepwise control as described above, continuous control of the flow rate is also possible.

### Eighth Embodiment

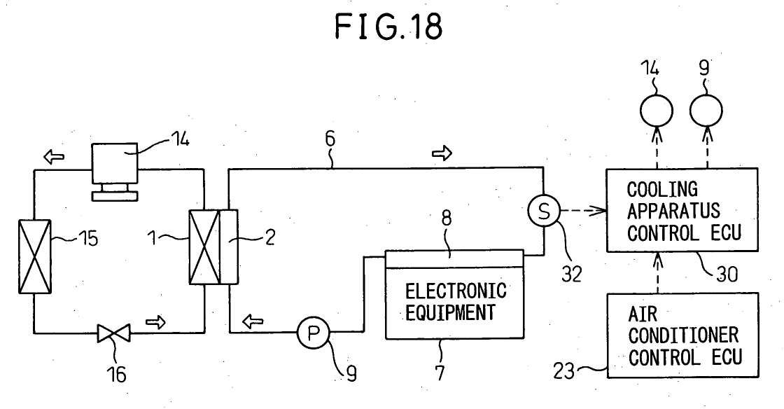

FIG. 18 is a view showing the construction of a brine type cooling apparatus according to e eighth embodiment of the invention. Like constituents as in the seventh embodiment described above are denoted by same reference numerals.

The brine type cooling apparatus of the present invention is applied to a vehicle equipped with an air conditioner unit 10 as shown in FIG. 1. An air conditioner control ECU 23 connected to the input side of the cooling apparatus control ECU 30 is added to the brine type cooling apparatus of FIG. 14 described in the seventh embodiment. This construction is for the cooling apparatus control ECU 30 to monitor the control of the compressor 14 by the air conditioner control ECU 23, and the control content of the air conditioner control ECU 23 is inputted to the cooling apparatus control ECU 30.

As in the seventh embodiment, also in the present embodiment, the heat radiating member 2 is in contact with the evaporator 1 so that heat can be conducted from the heat radiating member 2 to the refrigerant in the evaporator 1. As long as heat conduction from the heat radiating member 2 to the refrigerant in the evaporator 1 is possible, the heat radiating member 2 needs not be in direct contact with the evaporator 1, and a thermally conductive member may be interposed between the heat radiating member 2 and the evaporator 1. Thus, the heat radiating member 2 needs only to be thermally connected to the evaporator 1. As long as the heat radiating member 2 needs only to be thermally connected to the evaporator 1, the heat radiating member 2 may be disposed either inside or outside the air conditioning case.

In the brine type cooling apparatus of the present embodiment, the heat radiating member 2 is thermally connected to the evaporator 1 of the vehicle air conditioning apparatus. Here, although a dedicated fan must be used for promoting heat discharge from the heat radiating member 2 in usual brine type cooling apparatus, a dedicated fan is not necessary in the present embodiment, since heat is exchanged between the heat radiating member 2, hence brine, and the refrigerant via existing evaporator of the air conditioner unit 10. Thus, in accordance with the present embodiment, the number of components of the brine type cooling apparatus can be reduced.

However, there is a problem that, in the case where the amount of the refrigerant discharge from the compressor 14 of the air conditioner unit 10 is 0, that is, when the refrigerant is not circulated in the refrigeration cycle of the air conditioner unit 10, the brine cannot be cooled by the refrigerant and, thus, cooling capability of the brine type cooling apparatus cannot be ensured and the electronic equipment to be cooled is not adequately cooled.

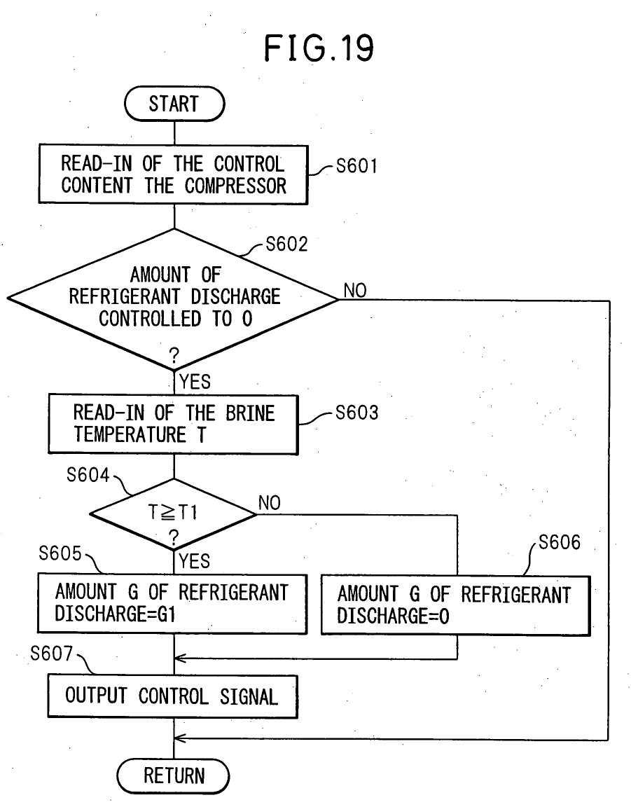

In order to resolve this problem, in the present embodiment, the refrigerant discharge control for circulating the refrigerant in the refrigeration cycle is executed by the cooling apparatus control ECU 30. FIG. 19 is a flow chart showing the refrigerant discharge control executed by the cooling apparatus control ECU 30. This refrigerant discharge control corresponds to the airflow rate control shown in FIG. 3 described in the first embodiment in which an airflow rate from the blower is replaced by the discharge from the compressor. The refrigerant discharge control starts when the electronic equipment 7 is started, and the flow shown in FIG. 19 is repeated until the control ends when the electronic equipment 7 is stopped.

Specifically, at step S601, the control content of the compressor 14 from the air conditioner control ECU 23 is read-in. The control content of the compressor 14 is that, when the automatic air conditioning switch 25a is OFF, the compressor 14 is started or stopped upon ON/OFF signal of the air conditioning switch 25c, and when the automatic air conditioning switch 25a is ON, the amount of refrigerant discharge of the compressor 14 is that decided by the air conditioner control ECU 23 before control signal is outputted to the compressor 14.

At step S602, it is determined whether or not the control content of the compressor 14 is the amount of refrigerant discharge controlled to 0. Here, if the control of the air conditioner control ECU 23 for air conditioning is to control the amount of refrigerant discharge of the compressor 14 to be 0, it is determined to be YES, and the flow proceeds to step S603. Here, the case where the control of the air conditioner control ECU 23 for air conditioning is to control the amount of refrigerant discharge of the compressor 14 to be 0 includes, for example, the case where the automatic air conditioning switch 25a is OFF and the air conditioner switch 25b is OFF, or the case where the automatic air conditioning switch 25a is ON and the amount of refrigerant discharge of the compressor 14 is decided to be 0 by the control of air conditioner control ECU 23 for air conditioning or due to system anomaly. On the other hand, in the case where the air conditioner control ECU 23 controls the amount of refrigerant discharge of the compressor 14 to be greater than 0, it is determined to be No, and the flow shown in FIG. 19 is terminated and the flow returns to START.

At step S603, the brine temperature T is read-in by the inlet water temperature sensor 32. Then, at step S604, as step S194 in FIG. 3, it is determined whether or not the brine temperature T read-in is equal to or higher than a predetermined threshold temperature T1. If the brine temperature is equal to or higher than, for example, 70° C., it is determined to be YES, and the flow proceeds to step S605. If the brine temperature is lower than, for example, 70° C., it is determined to be NO, and the flow proceeds to step S606.

At step S605, as the electronic equipment 7 needs to be cooled by the brine, the amount G of refrigerant discharge of the compressor 14 is decided to be a predetermined amount G1 greater than 0. On the other hand, at step S606, since the electronic equipment 7 needs not be cooled by the brine, the amount G of refrigerant discharge of the compressor 14 is decided to be 0. After steps S605, S606, at step S607, control signal is outputted to control the compressor 14 as decided.

In this way, in the present embodiment, in the case where the cooling apparatus control ECU 30 determines, at step S602, that the control content of the compressor 14 by the air conditioner control ECU 23 is that the amount G of refrigerant discharge should be 0, and at step S604, that the brine temperature T is equal to or higher than the threshold temperature T1, the compressor 14 is operated at steps S605, S607, to thereby circulate the refrigerant in the refrigeration cycle.

Thus, in accordance with the present embodiment, even when the compressor in the refrigeration cycle is stopped as the control for air conditioning, if it is required to cool the electronic equipment 7, the compressor 14 can be kept operating and cooling capability of the brine type cooling apparatus can be secured.

### Other Embodiments

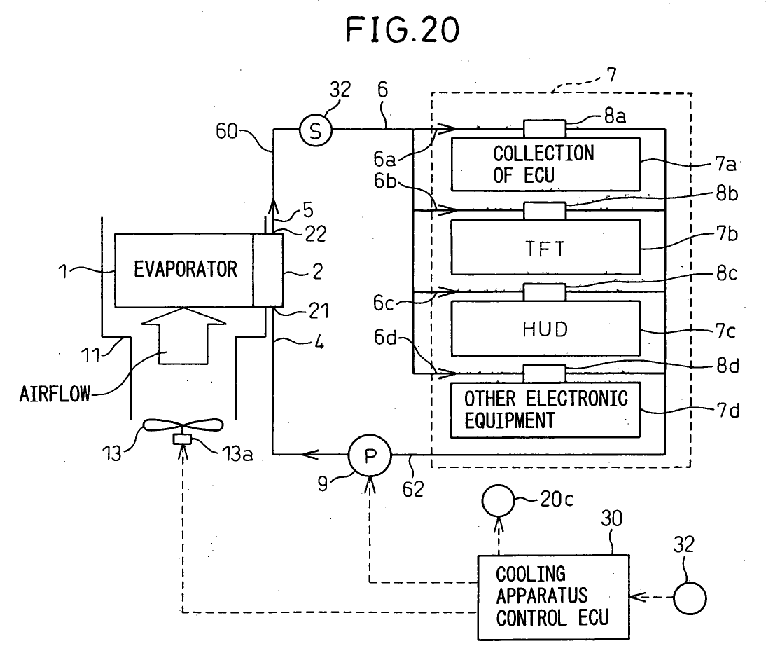

(1) FIG. 20 is a view showing the construction of a brine type cooling apparatus in another embodiment. The present embodiment is the first embodiment modified in part.

The brine type cooling equipment according to the present embodiment comprises a heat radiating plate 2 as a heat radiating member disposed in thermal connection to the evaporator 1, electronic equipments 7a˜7d as the objects to be cooled 7, heat absorbing plates 8a˜8d as heat absorbing members disposed in thermal connection to the electronic equipments 7a˜7d, brine pipelines. 6, 6a˜6d, 62 provided so as to connect and circulate the heat radiating plate 2 and heat absorbing plates 8a˜8d, and a circulation pump 9 for circulating the brine 60 in the brine pipelines 6, 6a˜6d, 62. Further, an inlet water temperature sensor 32 is provided on the upstream side of the electronic equipment 7 interposed in the brine pipeline 6 for detecting temperature Tin of the brine 60 in the brine pipeline 6.

The heat radiating plate 2 has a passage formed therein, and is connected to the inlet side brine pipeline 4 and to the outlet side brine pipeline 5 at the inlet opening 21 and at the outlet opening 22, respectively, provided at the ends of the passage. The brine 60 flows from the inlet side brine pipeline 4 into the interior of the heat radiating plate 2 and, there, exchanges heat with the evaporator 1 via the heat radiating plate 2 and the brazed portion 3, and flows out to the outlet side brine pipeline 5.

These inlet side and outlet side brine pipelines 4, 5 form parts of a loop-like brine pipeline 6. The brine pipeline 6 extending downstream from the outlet opening 22 is branched and passes the object to be cooled 7 as a plurality of brine pipelines 6a˜6d, is then combined into one pipeline, passes the circulation pump 9 and returns to the inlet opening 21 to form a loop. The brine 60 is circulated in the brine pipeline 6 in the above-described loop by the operation of the circulation pump 9.

The object to be cooled 7 consists of a collection of ECU 7a as a vehicle-mounted electronic equipment, TFT display panel 7b, HUD 7c and other electronic equipment 7d, each being thermally connected to the brine pipelines 6a˜6d via the heat absorption plates 8a˜8d as the heat absorbing member.

Also in other electronic equipments 7b˜7d of the object to be cooled 7, heat generated therein is transported to the outside by brine via the heat absorbing plates 8b˜8d and the temperature rise is thereby suppressed. The temperature rise is suppressed to the rated temperature permitting the normal operation of the electronic equipment, for example, about 40-60° C.

As has been described above, in the present embodiment, a loop-like brine pipeline 6 is thermally connected to the object to be cooled 7 as the heat absorbing member and to the evaporator 1 as the heat radiating member, and interconnects these heat absorbing member and heat radiating member. The brine 60 in the brine pipeline 6 is circulated in one direction by the circulation pump 9, to thereby transport the heat absorbed by the heat absorbing member in the brine 60 and discharge the heat from the brine 60 to the evaporator 1, and the brine flows in the brine pipeline 6 again to the heat absorbing member.

Also, in the present embodiment, when the blower 13 as an air conditioning apparatus is not in operation, for example in spring or autumn, the control ECU 30 operates the circulation pump 9 for circulating the brine 60 in the brine pipeline 6, 6a˜6d, 62, whereby the heat generated in various electronic equipments 7a˜7d of the object to be cooled 7 is recovered by the brine 60, and is transported to the heat radiating plate 2 as the heat radiating member. At the heat radiating plate 2, the heat recovered by the brine 60 is discharged to the evaporator 1. The control ECU 30 monitors the operation of the blower 13 based on the information from the air conditioner control ECU (not shown).

In this state, the control is executed such that, if the inlet side brine temperature Tin detected by the inlet water temperature sensor 32 exceeds the threshold temperature Tth1 (for example, 50° C.), the control ECU 30 turns the blower 13 ON, that is, the blower is started, and if Tin≦Tth1, the control ECU 30 turns the blower 13 OFF. In synchronism with the operation of the blower 13, the waste heat vent 19d is opened or closed. This threshold temperature Tth1 is set as the upper bound of the brine temperature that enables cooling of the electronic equipments 7a˜7d as the object to be cooled 7.

Thus, when the temperature of the object to be cooled 7 is low (Tin≦Tth1), only the circulation pump 9 is operated to discharge the heat recovered by the brine 60 to the evaporator 1 at no wind. From this state, when the temperature of the object to be cooled 7 rises so as to exceeds the threshold temperature (Tin≧Tth1), the blower 13 is turned ON to start the wind. Thus, the evaporator can be cooled by the fan to thereby increase the heat recovery efficiency, and the temperature of the electronic equipments 7a˜7d at the object to be cooled 7 can be suppressed so as not to exceed the near threshold temperature Tth1.

That is, since the evaporator 1 is fan-cooled by the wind from the blower 13, the heat absorption efficiency of the evaporator 1 can be improved. The existing blower 13 in the air conditioner unit 10 can be used for this air-cooling, and no additional cooling device is required.

Further, as the waste heat vent 19d is opened simultaneously with the operation of the blower 13, the air overheated in passing the evaporator 1 by the flow from the blower 13 can be discharged outside the air conditioner unit 10 from the waste heat vent 19d. Thus, the temperature in the air conditioner unit 10 is not excessively raised and the heat recovery efficiency of the evaporator 1 can be thereby improved. By providing the waste heat vent 19d near the feet of the occupant, effect of supplementing the heater assembly can be obtained.

In the present embodiment described above, in place of the inlet water temperature sensor 32 for detecting the brine temperature Tin on the inlet side of the object to be cooled 7, it is also possible to provide an outlet water temperature sensor for detecting the brine temperature Tout on the outlet side, and to control the operation of the blower 13 based on the brine temperature Tout.

Specifically, the control ECU 30 performs control such that, when the outlet brine temperature Tout as the detection signal of the outlet water temperature sensor exceeds the threshold temperature Tth2 (for example, 60° C.), the blower 13 is turned ON, that is, blowing is started, and when Tout≦Tth2, the blower 13 is turned OFF. This threshold temperature Tth2 is set as the upper bound of the brine temperature raised by cooling of the electronic equipment. In this way, the blower 13 can be turned ON in accordance with the rise of the outlet brine temperature Tout to thereby improve the heat recovery efficiency and to keep temperature of the electronic equipment 7a˜7d at the object to be cooled 7 lower than about threshold temperature Tth2.

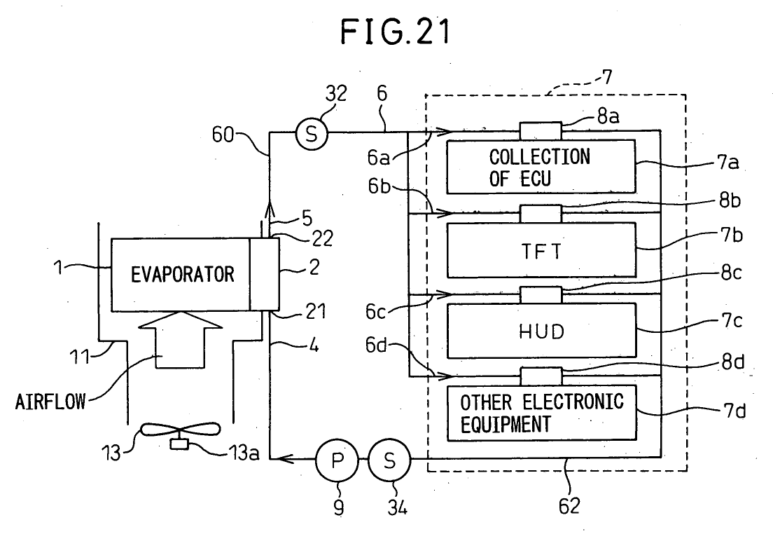

Further, as shown in FIG. 21, an inlet water temperature sensor 32 for detecting the brine temperature on the inlet side and/or an outlet water temperature sensor 34 for detecting the brine temperature on the outlet side of the object to be cooled 7 may be provided, and operation of the blower 13 may be controlled based on these brine temperatures.

Specifically, the control ECU 30 controls such that the blower 13 is turned ON when the difference (Tout−Tin) between the detection signal Tin of the inlet water temperature sensor 32 and the detection signal Tout of the outlet water temperature sensor 34 exceeds a threshold value (for example, 5° C.), and the blower 13 is turned OFF when (Tout−Tin)≦5° C.

Thus, the amount of heat absorption from the object to be cooled 7 is determined from the temperature difference between the inlet side and the outlet side of the object to be cooled. Therefore, in the above construction, the blower 13 is turned ON when the amount of heat absorption corresponding to the brine temperature difference between the inlet side and the outlet side exceeds the amount of heat discharge permitted as a natural cooling body on the side of the evaporator 1, and heat recovery efficiency of the evaporator 1 can be thereby be improved.

(2) Although thermal connection of the heat radiating members 2a, 2b to the evaporator 1 in the second embodiment described above, is obtained by brazing, it is also possible to obtain thermal connection by means of fixing with calking.

(3) Similarly, various other members can be adopted as the heat radiating member in each embodiment described above as long as the heat of brine can be effectively discharged. For example, as represented by the first embodiment, in the brine type cooling apparatus in which the heat radiating member is disposed at a location apart from the evaporator 1 in the air conditioning case 1, a tube fin heat exchanger may be used as the heat radiating member.

(4) Although in each of above-described embodiments, the cooling apparatus control ECU 30 for controlling the brine type cooling apparatus is described as a body separate from the air conditioner control ECU 23 for controlling various parts of the air conditioner unit 10, the present invention is not limited to such construction. It is also possible to control the brine type cooling apparatus by the air conditioner control ECU.

(5) Although in the first embodiment described above, the heat radiating member 2 is disposed at a location on the air flow upstream side of the evaporator 1 in the air conditioning case 11, the heat radiating member 2 may be disposed at any location, as long as it is exposed to the air flow from the blower 13 in the air conditioning case 11. For example, it may be disposed at a location on the downstream side of the evaporator 1 where it is exposed to the wind after passing the evaporator 1, except that, on the downstream side of the evaporator 1, a location downstream of the heater core is undesirable. As the amount of heat discharge from the brine is different depending upon the location of the heat radiating member, it is preferred to adjust the brine flow rate in the brine circuit so as to obtain proper brine temperature. For example, although brine may be overcooled on the downstream side of the evaporator 1, the brine flow rate can be adjusted using a pump to avoid overcooling.

Similarly, in the fourth embodiment, location of the heat radiating member 2 may be changed to any location as long as it is exposed to the external air introduced into the air conditioning case 11. Also, in the fifth embodiment, location of the heat radiating member 2 and the dedicated fan 26 may be changed to any location in the air conditioning case 11.

(6) In the first embodiment, at step S105, the case where airflow rate Va of the blower 13 is decided to be a predetermined flow rate Va1 greater than 0, and the state of the foot vent 19c is decided to be OPEN, is described. It is also possible to decide that at least one of the defroster vent 19a and the foot vent 19c be OPEN. That is, when the blower 13 is in operation, the wind may be discharged from at least one of the defroster vent 19a and the foot vent 19c.

(7) Although, in the first embodiment as described above, the heat radiating member 2 is disposed at a location apart from the evaporator 1, it is also possible to thermally connect the heat radiating member 2 to the evaporator 1.

(8) In the 1^{st}˜5^{th} embodiments, at step S102 in the first embodiment, for example, before the air conditioner control ECU 23 outputs control signal to the blower 13, the cooling apparatus control ECU 30 determines whether or not the control state of the blower 13 is the stopping control. However, the cooling apparatus control ECU 30 may instead determine whether or not the stopping control for the blower 13 has been outputted by the air conditioner control ECU 23. That is, the cooling apparatus control ECU 30 may determine whether or not the blower 13 is in stopping state.

Similarly, in eighth embodiment, it is also possible to determine whether or not the amount of refrigerant discharged from the compressor 14 is 0.

(9) In each of the embodiments described above, an inlet water temperature sensor 32 for detecting the brine temperature on the inlet side of the heat absorbing member 8 is used as the temperature sensor for detecting the temperature of the brine. However, an outlet water temperature sensor 34 for detecting the brine temperature on the outlet side of the heat absorbing member 8 may also be used.

Also, in each of the embodiments described above, the temperature of the electronic equipment to be cooled is estimated by detecting the brine temperature. However, it is also possible to measure another physical quantity as long as the temperature of the electronic equipment can be known or estimated. Thus, as detection means for detecting a physical quantity relating to the temperature of the object to be cooled, it is also possible to adopt a temperature sensor for detecting temperature of the electronic equipment, temperature of the heat radiating member 2, air temperature after passing the heat radiating member 2, etc., in place of the temperature sensor for detecting the brine temperature.

(10) In seventh and eighth embodiments, the heat radiating member 2 is thermally connected to the evaporator 1. However, the heat radiating member 2 may also be thermally connected to the low pressure path side of the refrigeration cycle so as to permit heat conduction from the heat radiating member 2 to the refrigerant.

While the invention has been described by reference to specific embodiments chosen for purpose of illustration, it should be apparent, to those skilled in the art, that numerous modification could be made thereto without departing from the basic concept and scope of the invention.

1. A brine-type vehicle cooling apparatus to be mounted on a vehicle equipped with an air conditioning case which forms an air passage for flowing air into the vehicle room, a blower for generating air flow in said air conditioning case toward the vehicle room, an evaporator disposed in said air conditioning case for cooling air in said air conditioning case by evaporating the refrigerant circulated in refrigeration cycle, and air conditioner control means for controlling the airflow rate of said blower for air conditioning, said apparatus comprising:
a heat absorbing member for absorbing heat of a vehicle-mounted object to be cooled into brine to thereby cool said object to be cooled;
a heat radiating member for discharging heat from the brine to the air in said air conditioning case;
a circulation pump for circulating brine between said heat absorbing member and said heat radiating member; and
cooling apparatus control means which, in the case where the control content of said blower for air conditioning executed by said air conditioner control means is stopping control of said blower, and when said object to be cooled needs to be cooled by brine, control so as to let flow the air in said air conditioning case to thereby air cool said heat radiating member.

2. A brine-type vehicle cooling apparatus according to claim 1, further comprising detection means for detecting a physical quantity related to temperature of said object to be cooled;
wherein, when the physical quantity detected by said detection means exceeds a predetermined first threshold value, said cooling apparatus control means execute control such that, by operating said blower with airflow rate set at a predetermined flow rate greater than 0, the air in said air conditioning case is let flow and said heat radiating member is thereby air cooled.

3. A brine-type vehicle cooling apparatus according to claim 2, wherein said detection means is a temperature sensor for detecting temperature of the brine, and wherein said cooling apparatus control means operate said blower when the temperature of the brine (Tin, Tout) detected by said temperature sensor exceeds threshold temperature (Tth1, Tth2).

4. A brine-type vehicle cooling apparatus according to claim 1, further comprising:
heat radiating member blowing means which are provided in said air conditioning case separately from said blower and which send airflow to said heat radiating member; and
detection means for detecting a physical quantity related to temperature of said object to be cooled;
wherein said cooling apparatus control means execute control such that, when the physical quantity detected by said detection means exceeds a predetermined first threshold value, by operating said heat radiating member blowing means with airflow rate set at a predetermined flow rate greater than 0, the air in the air conditioning case is let flow, and said heat radiating member is thereby air cooled.

5. A brine-type vehicle cooling apparatus according to claim 1, further comprising detection means for detecting a physical quantity related to temperature of said object to be cooled;
wherein an internal/external air switching door is provided on the inlet side of said air conditioning case for switching between the introduction of air from inside of the vehicle room and the introduction of air from outside of the vehicle room; and
wherein said cooling apparatus control means execute control such that, when the physical quantity detected by said detection means exceeds a predetermined first threshold value, by positioning said internal/external air switching door so as to obtain the introduced air from outside of the vehicle room at a predetermined rate greater than 0, the air in the air conditioning case is let flow, and said heat radiating member is thereby air cooled.

6. A brine-type vehicle cooling apparatus according to claim 1, wherein a waste heat vent provided at a position different from the vent for air conditioning, and a waste heat vent opening/closing door for opening/closing of said waste heat vent are provided, and
wherein said cooling apparatus control means execute control such that, when the air in said air conditioning case is to be let flow, said waste heat vent opening/closing door is positioned so as to open said waste heat vent.

7. A brine-type vehicle cooling apparatus according to claim 1, wherein, in said air conditioning case, there are provided a defroster vent for discharging air conditioned wind toward the front window glass of the vehicle, a foot vent for discharging air conditioned wind toward the feet of the occupant, and a defroster door and a foot door for opening/closing said defroster vent and said foot vent, respectively, and
wherein said cooling apparatus control means execute control such that, when the air in said air conditioning case is to be let flow, said defroster door and said foot door are positioned so as to open at least one of said defroster vent and said foot vent.

8. A brine-type vehicle cooling apparatus to be applied to a vehicle equipped with an air conditioning case which forms air passage for passing air into the vehicle room, an evaporator disposed in said air conditioning case for cooling air in said air conditioning case by evaporating the refrigerant circulated in refrigeration cycle, a compressor for discharging refrigerant and circulating refrigerant in said refrigeration cycle, and air conditioner control means for controlling the amount of refrigerant discharged by said compressor, said apparatus comprising:
a heat absorbing member for absorbing heat of a vehicle-mounted object to be cooled into brine to thereby cool said object to be cooled;
a heat radiating member thermally connected to the low pressure path side of said refrigeration cycle for discharging heat from brine to the refrigerant in said refrigeration cycle;
a pump for circulating brine between said heat absorbing member and said heat radiating member; and
cooling apparatus control means which, in the case where the control content of said compressor for air conditioning executed by said air conditioner control means is for the amount of refrigerant discharged by said compressor to be 0, and when said object to be cooled needs to be cooled by brine, control said compressor to discharge refrigerant to thereby circulate the refrigerant in the refrigeration cycle and control said heat radiating member to discharge heat to the refrigerant.

9. A brine-type vehicle cooling apparatus according to claim 8, further comprising detection means for detecting a physical quantity related to the temperature of said object to be cooled;
wherein, when the physical quantity detected by said detection means exceeds a predetermined first threshold value, said cooling apparatus control means control said compressor to discharge refrigerant at predetermined rate greater than 0.

10. A brine-type vehicle cooling apparatus according to claim 1, wherein said heat radiating member is thermally connected to said evaporator for discharging heat from brine to refrigerant in said evaporator.

11. A brine type cooling apparatus which has a brine circuit with brine circulated as a heat exchanging medium provided to a refrigeration cycle via a heat radiating member constructed in thermally conductive contact with the low pressure path side of said refrigeration cycle, and has a vehicle-mounted electronic equipment to be cooled interposed in said brine circuit via a heat absorbing member constructed in thermally conductive contact with the vehicle-mounted electronic equipment,
wherein operation of a compressor in said refrigeration cycle is controlled based on the temperature of the brine circulated in said brine circuit.

12. A brine-type cooling apparatus according to claim 11, wherein said heat radiating member is constructed in thermally conductive contact with an evaporator in the low pressure path side of said refrigeration cycle.

13. An operation control method of a brine-type cooling apparatus according to claim 12 comprising successive continuation of the control procedure including:
a step (S100) of reading-in temperature (Ta) of the brine circulated in said brine circuit;
a step (S101) of determining whether or not said brine temperature (Ta) is equal to or lower than a first predetermined temperature (T2) set in advance lest said vehicle-mounted electronic equipment is excessively cooled to cause dew condensation;
a step (S102) of turning said compressor OFF and returning to START if said brine temperature (Ta) is equal to or lower than said first predetermined temperature (Ta≦T2);
a step (S103) of determining whether or not said brine temperature (Ta) is equal to or higher than a second predetermined temperature (T1) set in advance lest the brine temperature overheats said vehicle-mounted electronic equipment if said brine temperature (Ta) is higher than said first predetermined temperature (Ta>T2); and
a step (S104) of turning said compressor (14) ON and returning to START if said brine temperature (Ta) is equal to or higher than said second predetermined temperature (T1≦Ta).

14. A brine-type cooling apparatus which has a brine circuit with brine circulated as a heat exchanging medium provided to a refrigeration cycle via a heat radiating member constructed in thermally conductive contact with an evaporator in the low pressure path side of said refrigeration cycle, and has a vehicle-mounted electronic equipment to be cooled interposed in said brine circuit via a heat absorbing member constructed in thermally conductive contact with the vehicle-mounted electronic equipment,
wherein operation of a compressor in said refrigeration cycle and a pump in said brine circuit is controlled based on monitoring of the temperature (Ta) of the brine circulated in said brine circuit as well as monitoring of the state of said evaporator.

15. An operation control method of a brine-type cooling apparatus according to claim 12 comprising successive continuation of the control procedure including:
a first step (S200) of reading-in temperature (Ta) of brine circulated in said brine circuit while reading-in air temperature (Tb) after passing said evaporator;
a second step (S201) of determining whether or not said air temperature (Tb) is equal to or lower than a first predetermined temperature (T4) set in advance lest said evaporator is excessively cooled to cause freezing, and if said air temperature is equal to or lower than said first predetermined temperature (Tb≦T4), proceeding to a third step (S202) of turning said compressor OFF, or if said air temperature is higher than said first predetermined temperature (Tb>T4), proceeding to a seventh step (S206) of determining whether or not said air temperature (Tb) is equal to or higher than a second predetermined temperature (T3) set in advance lest said air temperature overheats said evaporator;
a fourth step (S203) of proceeding from said third step (S202) and determining whether or not brine temperature (Ta) is equal to or higher than a third predetermined temperature (T1) set in advance lest said vehicle-mounted electronic equipment is over heated, and if the brine temperature is equal to or higher than a third predetermined temperature (T1≦Ta), proceeding to a fifth step (S203) of controlling output of said pump to be a first flow rate (G1) and returning to START, or if the brine temperature is lower than a third predetermined temperature (T1>Ta), proceeding to a sixth step (S205) of controlling output of said pump to be a second flow rate (G2) less than the first flow rate (G1) and returning to START;
a seventh step (S206) of determining whether or not said air temperature (Tb) is equal to or higher than a fourth predetermined temperature (T3) set in advance lest said evaporator is overheated, and if said air temperature is equal to or higher than the fourth predetermined temperature (T3≦Tb), proceeding to a eighth step (S207) of turning said compressor ON, or if said air temperature is lower than the fourth predetermined temperature (T3>Tb), proceeding to a twelfth step (S211) of determining whether or not the brine temperature is equal to or higher than said third predetermined temperature (T1≦Ta);
a ninth step (S208) of proceeding from said eighth step (S207) and determining whether or not the brine temperature (Ta) is equal to or lower than a fourth predetermined temperature (T2) set in advance lest said vehicle-mounted electronic equipment is excessively cooled to cause dew condensation, and if the brine temperature is equal to or lower than said fourth predetermined temperature (Ta≦T2), proceeding to a tenth step (S209) of controlling output of said pump to be a third flow rate (G2) less than said second flow rate (G) and returning to START, or if the brine temperature is higher than said fourth predetermined temperature (Ta>T2), proceeding to a eleventh step (S210) of controlling output of said pump to be said second flow rate (G) and returning to START;
a twelfth step (S211) of determining whether or not the brine temperature is equal to or higher than said third predetermined temperature (T1≦Ta), and if the brine temperature is equal to or higher than said third predetermined temperature (T1≦Ta), proceeding to a thirteenth step (S212) of determining whether or not said compressor is ON, or if the brine temperature is lower than said third predetermined temperature (T1>Ta), proceeding to a sixteenth step (S215) of determining whether or not the brine temperature is equal to or lower than said fourth predetermined temperature (Ta≦T2);
a thirteenth step (S212) of determining whether or not said compressor is ON, and if said compressor is ON, proceeding to a fourteenth step (S213) of controlling output of said pump to be said second flow rate (G) and returning to START, or if said compressor is OFF, proceeding to a fifteenth step (S214) of controlling output of said pump to be said first flow rate (G1) and returning to START;
a sixteenth step (S215) of determining whether or not the brine temperature is equal to or lower than said fourth predetermined temperature (Ta≦T2), and if the brine temperature is equal to or lower than said fourth predetermined temperature (Ta≦T2), and if the brine temperature is equal to or lower than said fourth predetermined temperature (Ta≦T2), proceeding to a seventeenth step (S216) of determining whether or not said compressor is ON, if the brine temperature is higher than said fourth predetermined temperature (Ta>T2), proceeding to a twentieth step (S219) of controlling output of said pump to be said second flow rate (G) and returning to START; and
a seventeenth step (S216) of determining whether or not said compressor is ON, and if said compressor is ON, proceeding to a eighteenth step (S217) of controlling output of said pump to be said third flow rate (G2) and returning to START, or if said compressor is OFF, proceeding to a nineteenth step (S218) of controlling output of said pump to be said first flow rate (G) and returning to START.
